(19) United States
(12) Patent Application Publication
(10) Pub. No.: US 2017/0300160 A1
(43) Pub. Date: Oct. 19, 2017

(54) TOUCH DISPLAY DEVICE

(71) Applicant: InnoLux Corporation, Miao-Li County (TW)

(72) Inventor: Chia-Hao TSAI, Miao-Li County (TW)

(21) Appl. No.: 15/489,028

(22) Filed: Apr. 17, 2017

Related U.S. Application Data
(60) Provisional application No. 62/323,880, filed on Apr. 18, 2016.

(30) Foreign Application Priority Data
Jun. 17, 2016 (TW) 105119075

(51) Int. Cl. G06F 3/041; G02F 1/1368; G02F 1/1335; G02F 1/1362; G02F 1/1343; G06F 3/044; G02F 1/1333

(52) U.S. Cl. CPC G06F 3/0414; G06F 3/044; G06F 3/0416; G02F 1/1368; G02F 1/13338; G02F 1/133514; G02F 1/136286; G02F 1/134309; G02F 1/133345; G02F 2201/121; G02F 2201/123

(57) ABSTRACT

A touch display device is provided. The touch display device includes a first substrate, a second substrate, a first electrode, a second electrode, and a third electrode. The first substrate includes a plurality of pixels and a plurality of thin film transistors. The second substrate is disposed opposite to the first substrate. The first electrode is disposed over the first substrate. The first electrode is used to detect a planar-touch event. The second electrode is disposed over the first substrate. The second electrode is electrically isolated from the first electrode. The third electrode is disposed over the second substrate. The second electrode and the third electrode are used to detect a press-touch event.

### CROSS REFERENCE TO RELATED APPLICATIONS

This application claims priority of Taiwan Patent Application No. 105119075, filed on Jun. 17, 2016, and also claims the benefit of priority from a provisional application of, U.S. Patent Application No. 62/323,880 filed on Apr. 18, 2016 and the entirety of which is incorporated by reference herein.

### BACKGROUND OF THE INVENTION

### Field of the Invention

The disclosure relates to a touch display device, and in particular to a touch display device with force sensing function.

### Description of the Related Art

Touch display devices are widely used in various electronic devices such as smartphones, panels, notebooks, etc. In order to improve these devices for their users, a touch display device with force sensing function has been developed. This touch display device may not only detect the trajectory of finger or stylus on the touch plane, but also responds to different levels of pressure to trigger the corresponding operations. However, this touch display device needs an additional pressure-sensing structure on the back of the panel, which in turn increases the cost and makes the manufacturing process more difficult. In addition, the additional pressure-sensing structure may increase the thickness of the panel or affect the transmittance of the liquid-crystal panel.

Therefore, an improvement of the touch display device with force sensing functionality and a decrease of its cost are needed.

### BRIEF SUMMARY OF THE INVENTION

The present disclosure provides a touch display device, including a first substrate, a second substrate, a first electrode, a second electrode, and a third electrode. The first substrate includes a plurality of pixels and a plurality of thin film transistors. The second substrate is disposed opposite to the first substrate. The first electrode, disposed over the first substrate, is used to detect a planar-touch event. The second electrode, disposed over the first substrate, is electrically isolated from the first electrode. The third electrode is disposed over the second substrate. The second electrode and the third electrode are used to detect a press-touch event.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1A is a top view of a touch display device in accordance with some embodiments of the present disclosure;

FIG. 1B is a cross-sectional view of a touch display device in accordance with some embodiments of the present disclosure;

FIG. 2A is a top view of a first electrode and a second electrode in accordance with some embodiments of the present disclosure;

FIG. 2B is a top view of a first electrode and a second electrode in accordance with some other embodiments of the present disclosure;

FIG. 2C is a top view of a first electrode and a second electrode in accordance with some other embodiments of the present disclosure;

FIG. 2D is a top view of a first electrode and a second electrode in accordance with some other embodiments of the present disclosure;

FIG. 3A is a top view of a third electrode in accordance with some embodiments of the present disclosure;

FIG. 3B is a top view of a third electrode in accordance with some other embodiments of the present disclosure;

FIG. 3C is a top view of a third electrode in accordance with some other embodiments of the present disclosure;

FIG. 4A is a cross-sectional view of a touch display device in accordance with some embodiments of the present disclosure;

FIG. 4B is an equivalent circuit diagram of the touch display device in FIG. 4A;

FIG. 4C is a cross-sectional view of a touch display device in accordance with some embodiments of the present disclosure;

FIG. 4D is an equivalent circuit diagram of the touch display device in FIG. 4C;

FIG. 4E is a wave shape figure of the output sensing signal in accordance with some embodiments of the present disclosure;

FIG. 4F is a cross-sectional view of a touch display device in accordance with some embodiments of the present disclosure;

FIG. 4G is an equivalent circuit diagram of the touch display device in FIG. 4F;

FIG. 5A is a cross-sectional view of a touch display device in accordance with some embodiments of the present disclosure;

FIG. 5B is an equivalent circuit diagram of the touch display device in FIG. 5A;

FIG. 5C is a cross-sectional view of a touch display device in accordance with some embodiments of the present disclosure;

FIG. 5D is an equivalent circuit diagram of the touch display device in FIG. 5C;

FIG. 5E is a wave shape figure of the output sensing signal in accordance with some embodiments of the present disclosure;

FIG. 6 is a cross-sectional view of a touch display device in accordance with some other embodiments of the present disclosure;

FIG. 7 is a cross-sectional view of a touch display device in accordance with some other embodiments of the present disclosure;

FIG. 8A is a top view of a touch display device in accordance with some other embodiments of the present disclosure;

FIG. 8B is a cross-sectional view of a touch display device in accordance with some other embodiments of the present disclosure;

FIG. 8C is a top view of a touch display device in accordance with some other embodiments of the present disclosure;

FIG. 9A is a top view of a touch display device in accordance with some other embodiments of the present disclosure;

FIG. 9B is a cross-sectional view of a touch display device in accordance with some other embodiments of the present disclosure; and

FIG. 9C is a top view of a touch display device in accordance with some other embodiments of the present disclosure.

### DETAILED DESCRIPTION OF THE INVENTION

The touch display device of the present disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the present disclosure may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In addition, in this specification, expressions such as “first material layer disposed on/over a second material layer”, may indicate the direct contact of the first material layer and the second material layer, or it may indicate a non-contact state with one or more intermediate layers between the first material layer and the second material layer. In the above situation, the first material layer may not be in direct contact with the second material layer.

In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”.

The term “about” typically means +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. When there is no specific description, the stated value includes the meaning of “about”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another region, layer or section. Thus, a first element, component, region, layer, portion or section discussed below could be termed a second element, component, region, layer, portion or section without departing from the teachings of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

This description of the exemplary embodiments is intended to be read in connection with the accompanying drawings, which are to be considered part of the entire written description. The drawings are not drawn to scale. In addition, structures and devices are shown schematically in order to simplify the drawing.

In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The term “substrate” is meant to include devices formed within a transparent substrate and the layers overlying the transparent substrate. All needed transistor elements may already be formed over the substrate. However, the substrate is represented with a flat surface in order to simplify the drawing. The term “substrate surface” is meant to include the uppermost exposed layers on a transparent substrate, such as an insulating layer and/or metallurgy lines.

According to some embodiments of the present disclosure, on a first substrate, a first electrode is provided to detect a planar-touch event and a second electrode is provided to detect a press-touch event. With this configuration, the touch display device does not need an additional pressure-sensing unit to detect the press-touch event, and the controller does not need a specific signal channel to process the pressure-sensing signal from the pressure-sensing structure.

In addition, in some embodiments of the present disclosure, the first electrode used to detect the planar-touch event and the second electrode used to detect the press-touch event are electrically isolated from each other. Therefore, the first electrode and the second electrode may respectively transmit the planar-touch sensing signal and the press-touch sensing signal to the controller through independent and different signal channels. Therefore, the controller of some embodiments of the present disclosure may determine if the planar-touch event happens by the planar-touch sensing signal alone, and may determine if the press-touch event happens by the press-touch sensing signal alone.

In addition, since the touch display device of some embodiments of the present disclosure may determine if the press-touch event happens alone, the press sensitivity of the touch display device of some embodiments of the present disclosure may be more accurate, and multi-point and multi-stage pressure sensing may be realized.

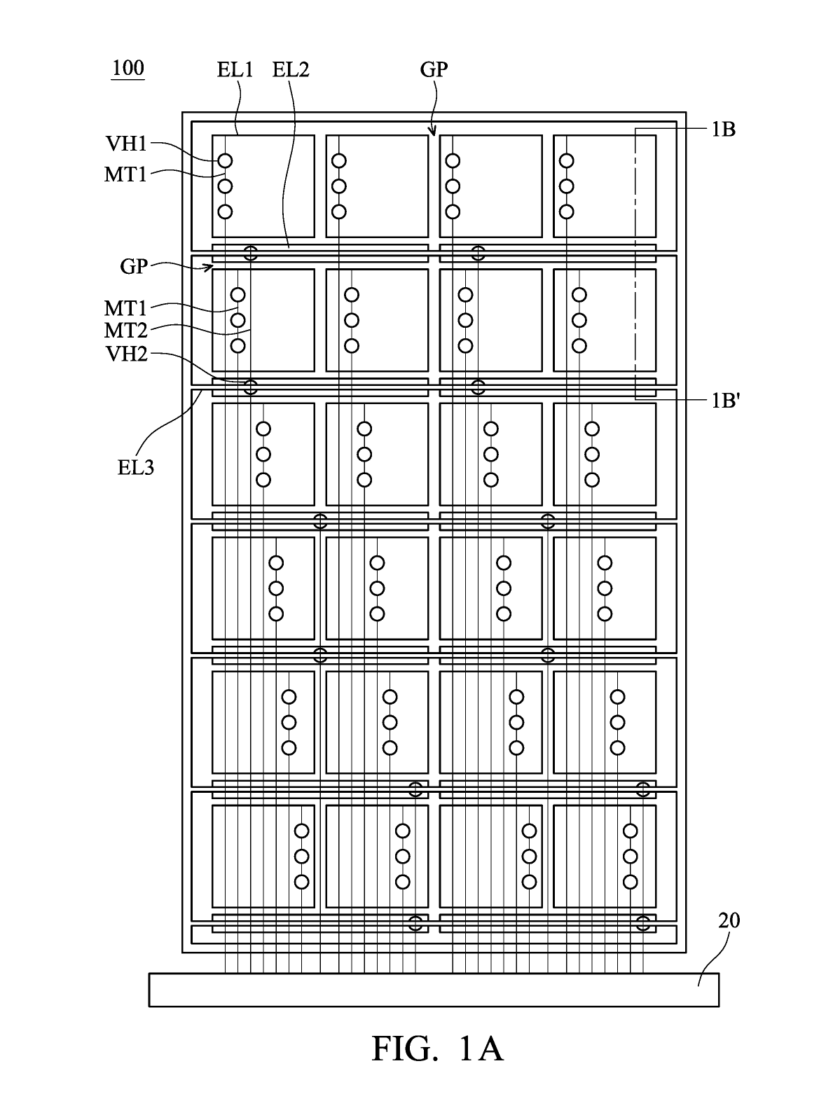

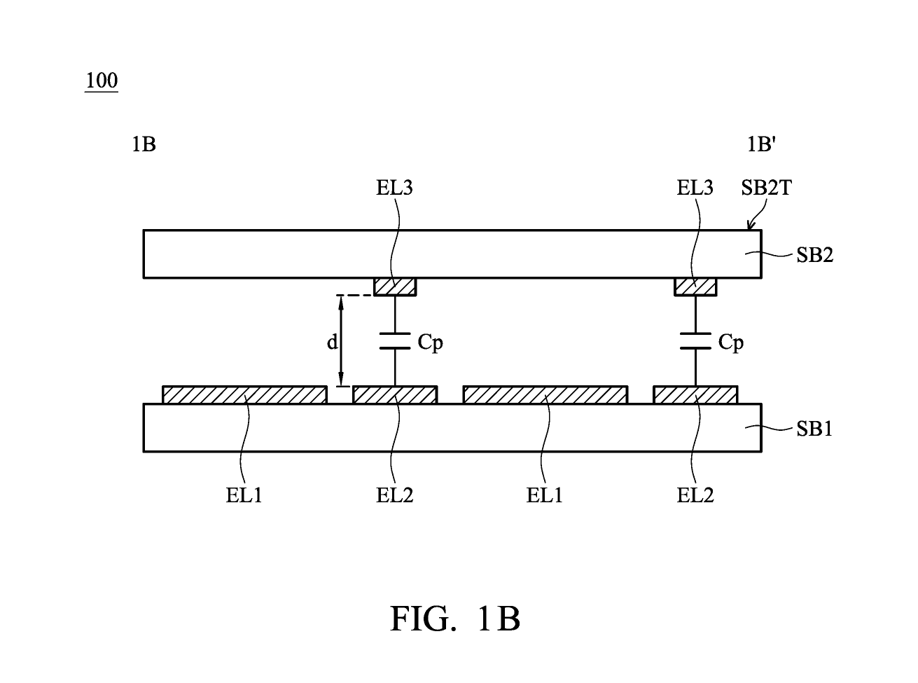

First, referring to FIGS. 1A-1B, FIG. 1A is a top view of a touch display device 100 in accordance with some embodiments of the present disclosure, FIG. 1B is a cross-sectional view along line 1B-1B′ in FIG. 1A in accordance with some embodiments of the present disclosure. As shown in FIGS. 1A-1B, according to some embodiments of the present disclosure, the touch display device 100 includes a first substrate SB1, a second substrate SB2, a first electrode EL1 and a second electrode EL2 disposed over the first substrate SB1, and a third electrode EL3 disposed over the second substrate SB2.

In some embodiments of the present disclosure, the first substrate SB1 is a thin film transistor (TFT) substrate. The first substrate SB1 includes a plurality of pixels and a plurality of thin film transistors (not shown in this figure), the second substrate SB2 is disposed opposite to the first substrate SB1. In some embodiments of the present disclosure, the second substrate SB2 may include, but is not limited to, a color filter substrate or a transparent substrate.

As shown in FIGS. 1A-1B, according to some embodiments of the present disclosure, the first electrode EL1 and the second electrode EL2 are disposed over the first substrate SB1, and are disposed between the first substrate SB1 and the second substrate SB2. The first electrode EL1 and the second electrode EL2 are electrically isolated from each other.

The voltage of the first electrode EL1 and the second electrode EL2 is controlled by the controller 20 in the touch display device 100, in one control cycle, the first electrode EL1 and the second electrode EL2 may selectively serve as a common electrode layer of the plurality of pixels over the first substrate SB1, or may selectively serve as a touch electrode layer which is used to detect the touch event. For example, when the touch display device 100 is operated in the display mode, the controller outputs the first signal (such as the common voltage) to the first electrode layer, such that the first electrode EL1 and the second electrode EL2 serve as a common electrode layer of the pixels. When the touch display device 100 is operated in the touch mode, the controller outputs the second signal (such as the touch sensing pulse) to the first electrode EL1 and the second electrode EL2, such that the first electrode EL1 and the second electrode EL2 serve as a touch electrode.

Still referring to FIGS. 1A-1B, according to some embodiments of the present disclosure, the third electrode EL3 is disposed over the second substrate SB2, and is disposed between the first substrate SB1 and the second substrate SB2. In addition, the third electrode EL3 over the second substrate SB2 is disposed corresponding to the second electrode EL2 over the first substrate SB1 in order to form a capacitance Cp with the second electrode EL2. The material of the third electrode EL3 may include, but is not limited to, transparent conductive materials or metal materials.

In addition, in some embodiments of the present disclosure, the first electrode EL1 disposed over the first substrate SB1 is used to detect the planar-touch event, whereas the second electrode EL2 disposed over the first substrate SB1 and the third electrode EL3 disposed over the second substrate SB2 are used to detect the press-touch event. The planar-touch event can be self-capacitive touch event, mutually capacitive touch event, resistive touch event, acoustic wave touch event, infrared touch event, or photosensitive touch event. In some embodiments, the first electrode EL1 can be a self-capacitive touch electrode. In some embodiments, the first electrode EL1 can be a drive electrode or a sense electrode. The press-touch event can be a force touch event. That is, the second electrode EL2 and the third electrode EL3 can be force sensors for detecting the force of a touch on the surface of the touch display device.

In particular, in some embodiments shown in FIG. 1A, the first electrode EL1 and the second electrode EL2 are configured by a self-capacitive in-cell structure. As shown in FIG. 1A, a plurality of first electrodes EL1 and second electrodes EL2 are disposed over the first substrate SB1. There is a gap GP between the plurality of first electrodes EL1, and the plurality of second electrodes EL2 are disposed in the gap GP. In some embodiments, the second electrodes EL2 can be disposed in the gap GP between two adjacent first electrodes EL1. Each first electrode EL1 is connected to the controller 20 by a metal line MT1, and each second electrode EL2 is connected to the controller 20 by a metal line MT2. The metal lines MT1 and MT2 are signal sources that are independent from each other. Therefore, the controller 20 may control the voltage of the first electrode EL1 by the metal line MT1, and make the first electrode EL1 serve as the common electrode of the pixels or the planar touch electrode. The controller 20 may control the voltage of the second electrode EL2 via the metal line MT2, and make the second electrode EL2 serve as the common electrode of the pixels or the press touch electrode.

In some embodiments of the present disclosure, the metal line MT1 and MT2 and the first electrode EL1 and the second electrode EL2 may be positioned at two different layers, and these two different layers are spaced apart by an insulating layer. The metal line MT1 and the corresponding first electrode EL1 may be electrically connected to each other by a via hole VH1 penetrating the insulating layer. The metal line MT2 and the corresponding second electrode EL2 may be electrically connected to each other by a via hole VH2 penetrating the insulating layer.

When the touch display device is operated in the touch mode, the controller 20 may sense the change in the signal coming from the first electrode EL1 through the metal line MT1, and generate an output sensing signal based on the sensed change in the signal. By judging the value of the output sensing signal, the controller 20 may determine whether a planar-touch event is happening.

In particular, when the object (for example, a finger, a stylus, or any other object which may be used to operate the touching operation) touches the top surface SB2T of the second substrate SB2, a capacitance is generated between the object and the first electrode EL1, such that the capacitance of the metal line MT1 which is electrically connected to the first electrode EL1 increases. Therefore, the controller 20 senses an increased signal from the metal line MT1. If the output sensing signal, which is generated based on the increased signal, is greater than a predetermined threshold value, the controller 20 may determine that a planar-touch event is happening.

In addition, when the touch display device is operated in the press-touch mode, the controller 20 may sense the change in the signal coming from the second electrode EL2 through the metal line MT2, and generate an output sensing signal based on the sensed change in the signal. By judging the value of the output sensing signal, the controller 20 may determine whether a press-touch event is happening.

In particular, according to some embodiments of the present disclosure, the gap d between the second electrode layer EL2 and third electrode layer EL3 is changed due to the external force. For example, when the finger presses the substrate, the gap d is reduced, and the capacitance Cp would increase. Therefore, the capacitance of the metal line MT2 which is electrically connected to the second electrode EL2 increases. Therefore, the controller 20 senses an increased signal from the metal line MT2. If the output sensing signal, which is generated based on the increased signal, is greater than a predetermined threshold value, the controller 20 may determine that the touch event taking place is a vertical (for example z direction) press-touch event (for example, press the touch screen with a certain force).

Accordingly, in some embodiments of the present disclosure, on the first substrate SB1, the first electrode EL1 used to detect the planar-touch event and the second electrode EL2 used to detect the press-touch event are disposed at the same time. With this configuration, the touch display device does not need an additional pressure-sensing unit to detect the press-touch event, and the controller does not need a specific signal channel to process the pressure-sensing signal from the pressure-sensing structure.

In addition, in some embodiments of the present disclosure, the first electrode EL1 used to detect the planar-touch event and the second electrode EL2 used to detect the press-touch event are electrically isolated from each other, such that the first electrode EL1 and the second electrode EL2 may respectively transmit the planar-touch sensing signal and the press-touch sensing signal to the controller 20 through independent and different signal channels (i.e. the above-mentioned metal line MT1 and the metal line MT2). Therefore, the controller 20 of some embodiments of the present disclosure may determine if the planar-touch event happens via the planar-touch sensing signal alone, and it may determine if the press-touch event happens via the press-touch sensing signal alone.

In addition, since the touch display device 100 of some embodiments of the present disclosure may determine if the press-touch event happens alone, the press sensitivity of the touch display device 100 of some embodiments of the present disclosure may be more accurate, and multi-point and multi-stage press sensing may be realized.

Still referring to FIGS. 1A-1B, according to some embodiments of the present disclosure, the third electrode EL3 does not overlap with the first electrode EL1 in order to prevent the third electrode EL3 from affecting the planar-touch detection of the first electrode EL1.

In addition, it should be noted that, although one second electrode EL2 merely corresponds to one third electrode EL3 in FIGS. 1A-1B, the present disclosure is not limited thereto. In some other embodiments, one second electrode EL2 may correspond to two or more third electrodes EL3, for example 3-20 third electrodes EL3.

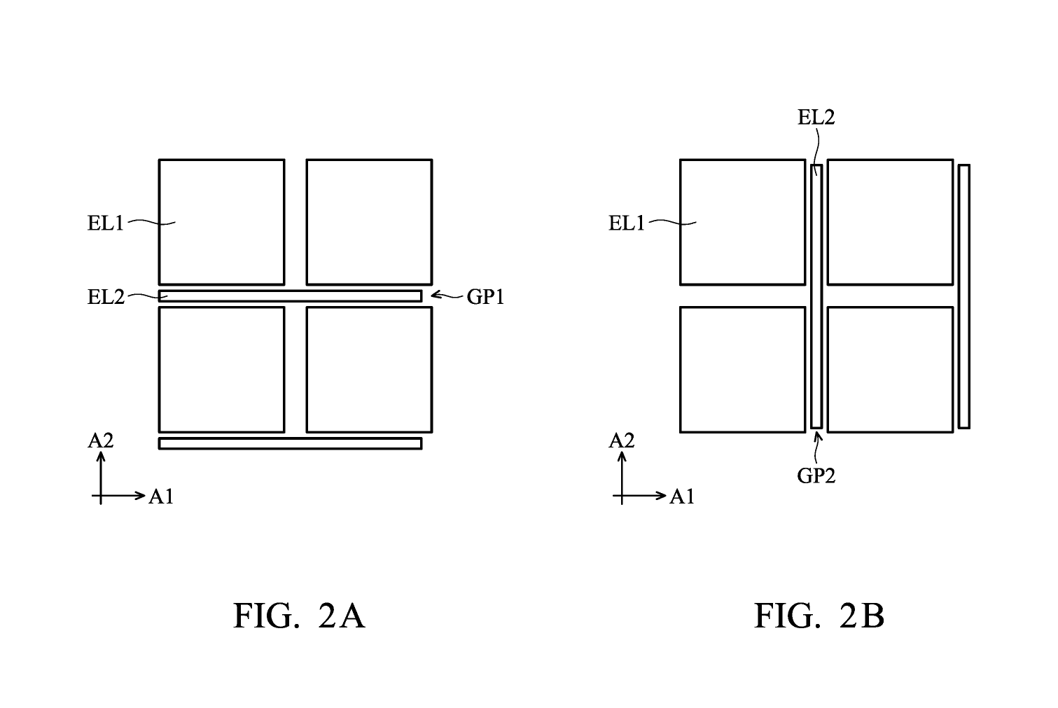

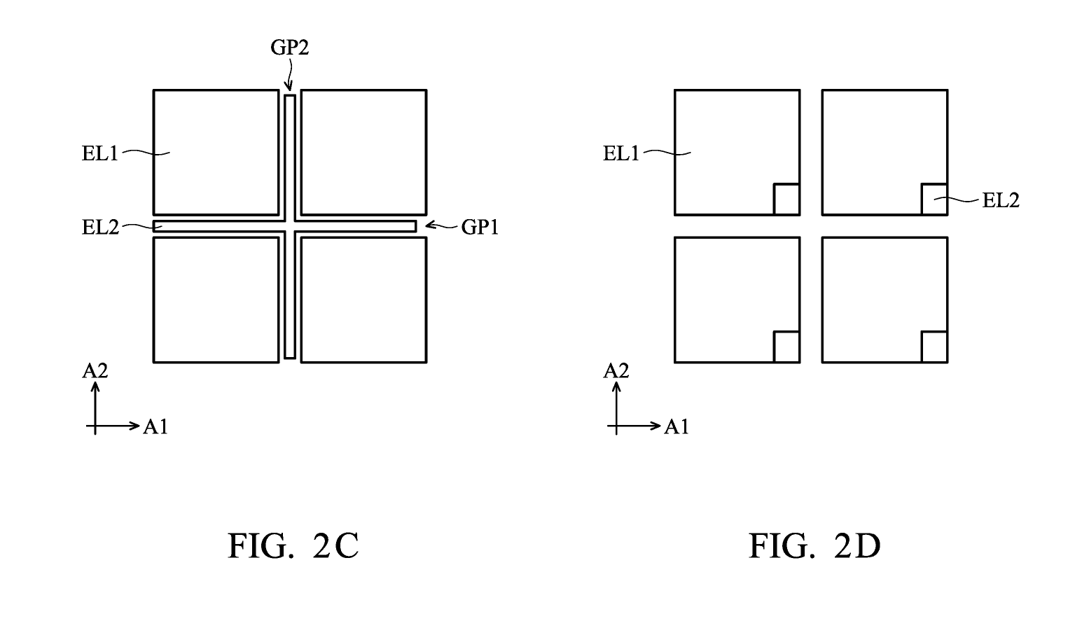

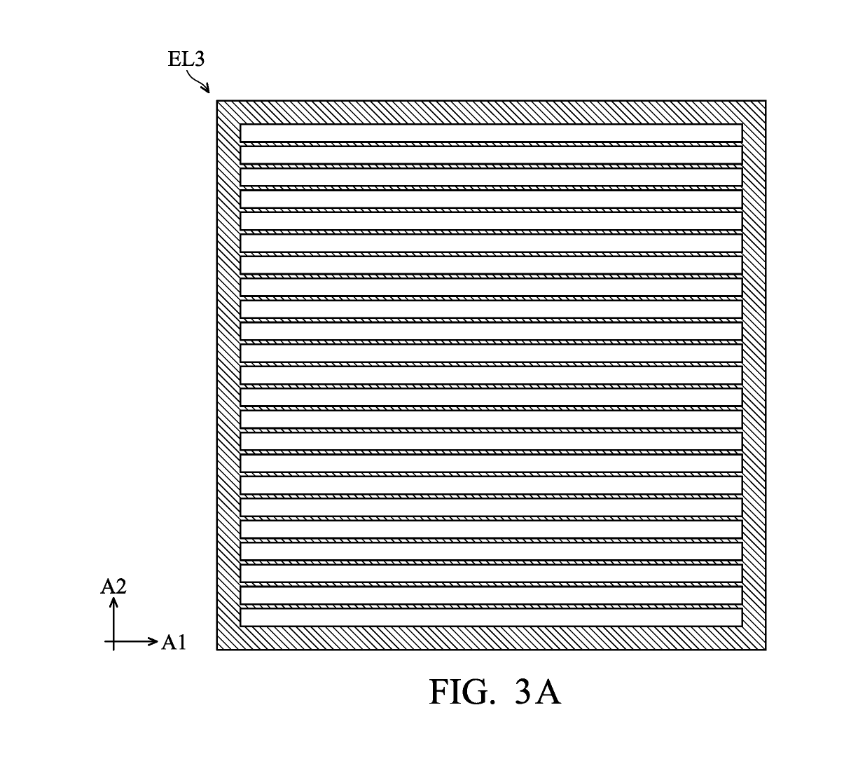

FIGS. 2A-2D are top views of different configurations of the first electrode and the second electrode in accordance with some embodiments of the present disclosure. As shown in FIG. 2A, according to some embodiments of the present disclosure, each transistor is electrically connected to the data line (not shown in this figure) and the scan line (not shown in this figure), and the data line and the scan line intersect each other. The scan line extends in a first direction A1, and the direction substantially perpendicular to the first direction A1 is a second direction A2. In some embodiments shown in FIG. 2A, the second electrode EL2 is disposed in the gap GP1 which is parallel to the first direction A1.

FIG. 2B is a top view of the first electrode EL1 and the second electrode EL2 in accordance with some other embodiments of the present disclosure. In this embodiment, the second electrode EL2 is disposed in the gap GP2 which is perpendicular to the first direction A1. As shown in FIG. 2B, the gap GP2 is parallel to the second direction A2.

FIG. 2C is a top view of the first electrode EL1 and the second electrode EL2 in accordance with some other embodiments of the present disclosure. In this embodiment, the second electrode EL2 is disposed in the gap GP1 which is parallel to the first direction A1 and is disposed in the gap GP2 which is perpendicular to the first direction A1 at the same time.

FIG. 2D is a top view of the first electrode EL1 and the second electrode EL2 in accordance with some other embodiments of the present disclosure. In this embodiment, the first electrode EL1 overlaps the second electrode EL2. In this embodiment, the first electrode EL1 and the second electrode EL2 may be positioned in two different layers, and the two different layers are spaced apart by an insulating layer.

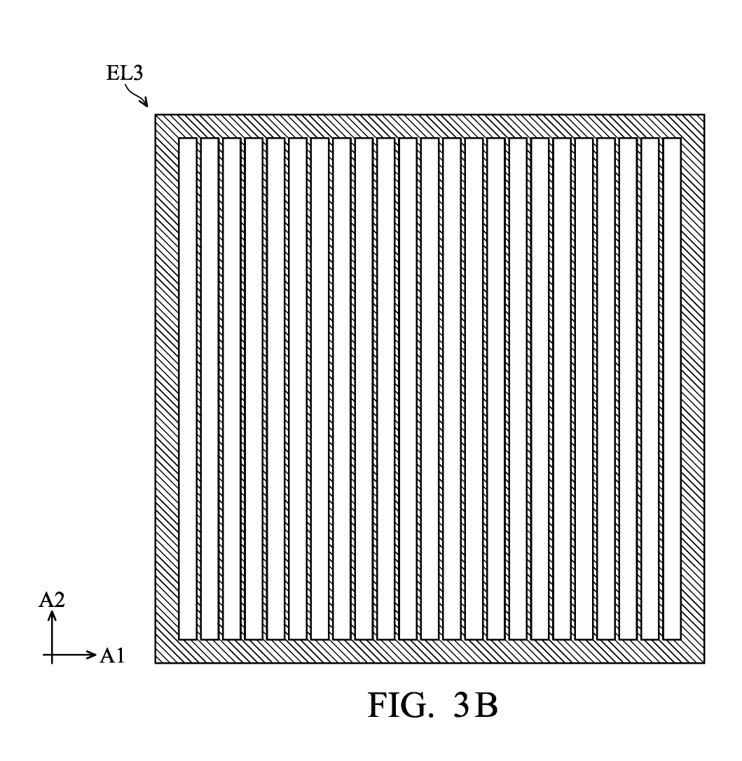

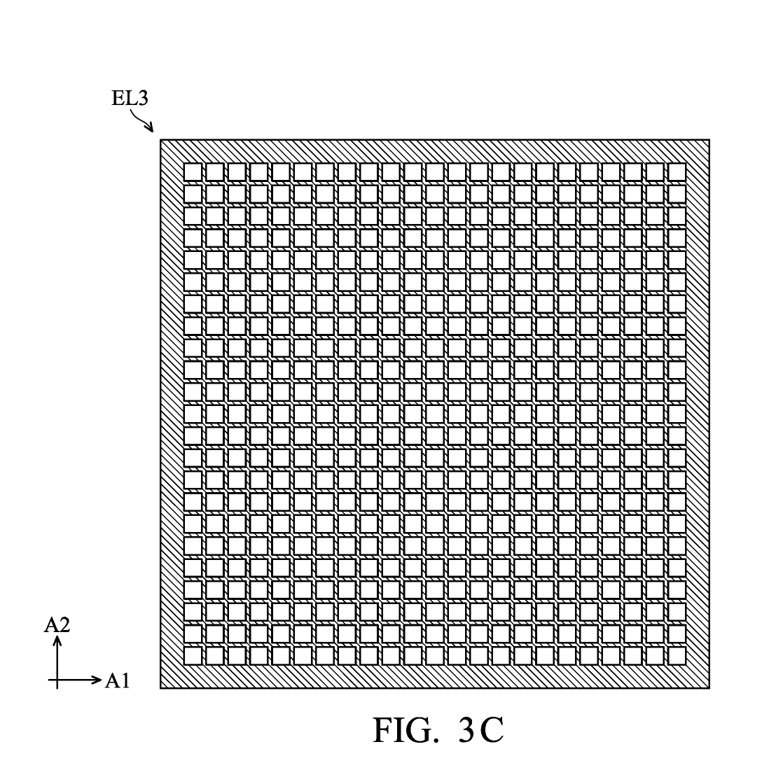

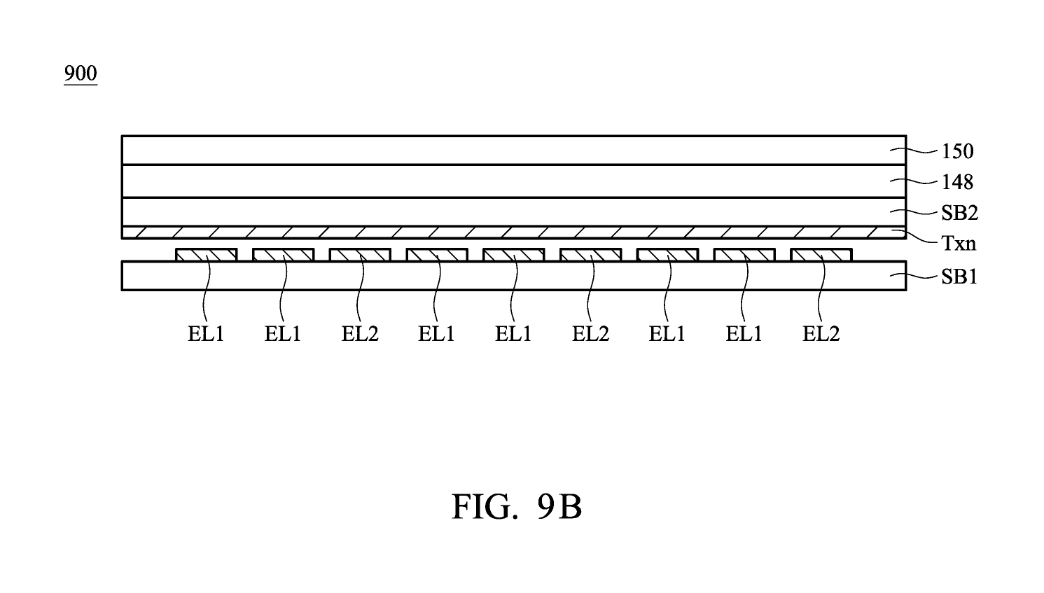

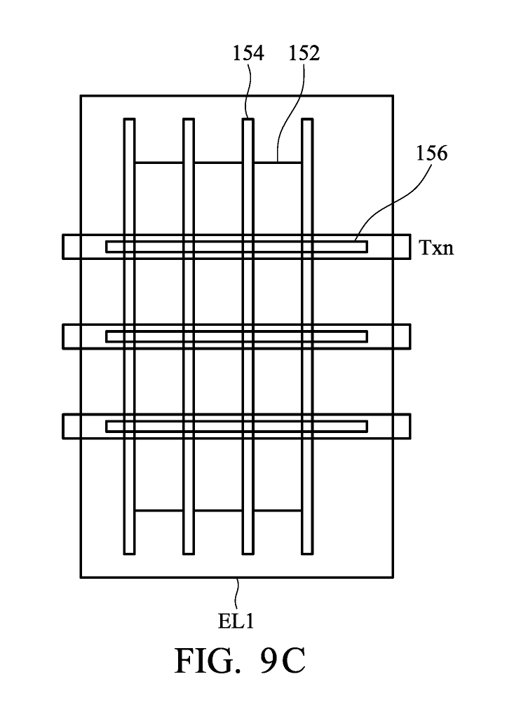

FIG. 3A-3C are top views of the third electrode EL3 in accordance with some embodiments of the present disclosure. Taking FIG. 3A for example, when the transistors in the first substrate SB1 are electrically connected to a plurality of data lines (such as the data lines shown in FIG. 9C) and a plurality of scan lines (such as the scan lines shown in FIG. 9C), and the data line and the scan line intersect each other, the electrode pattern of the third electrode EL3 can overlap with the scan line or can be parallel to the scan line (as shown in FIG. 3A). In other words, in this embodiment, the electrode pattern of the third electrode EL3 can be parallel to the first direction A1.

FIG. 3B is a top view of the third electrode EL3 in accordance with some other embodiments of the present disclosure. In this embodiment, the electrode pattern of the third electrode EL3 can overlap with the data line or can be parallel to the data line. In some embodiments of the present disclosure, if the data line extends in the second direction A2, the electrode pattern of the third electrode EL3 is parallel to the second direction A2.

FIG. 3C is a top view of the third electrode EL3 in accordance with some other embodiments of the present disclosure. In this embodiment, the electrode pattern of the third electrode EL3 overlaps with the data line and the scan line, or is parallel to the data line and the scan line at the same time to form a mesh pattern or a grid pattern.

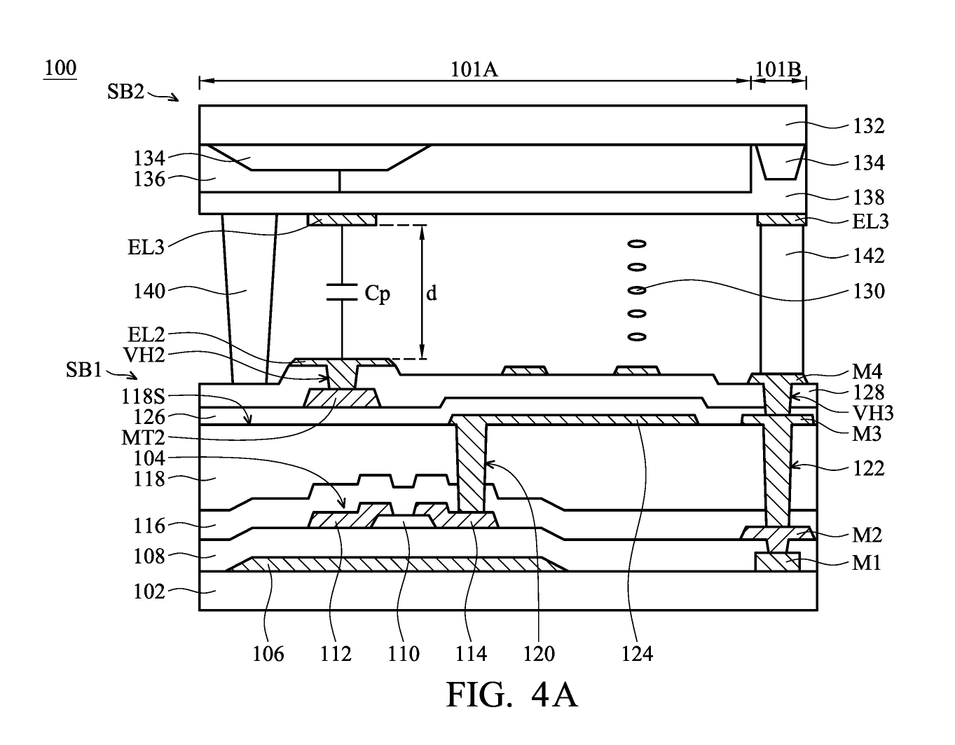

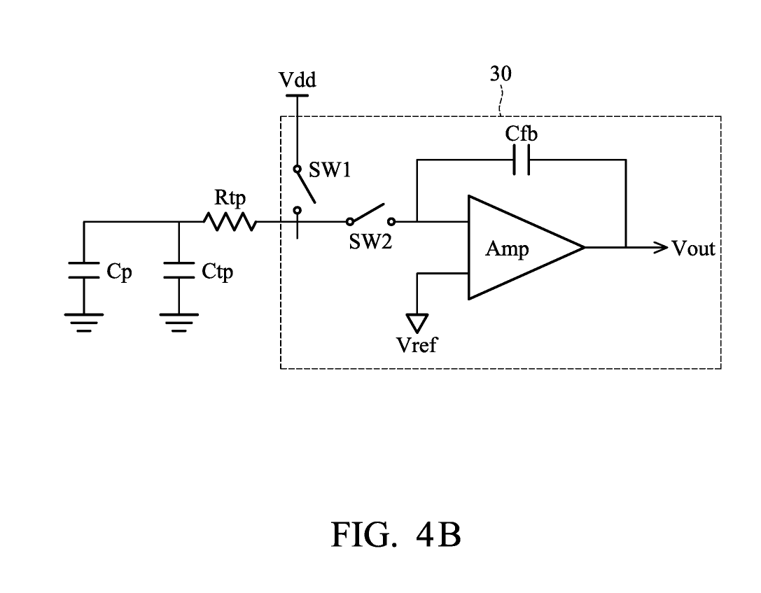

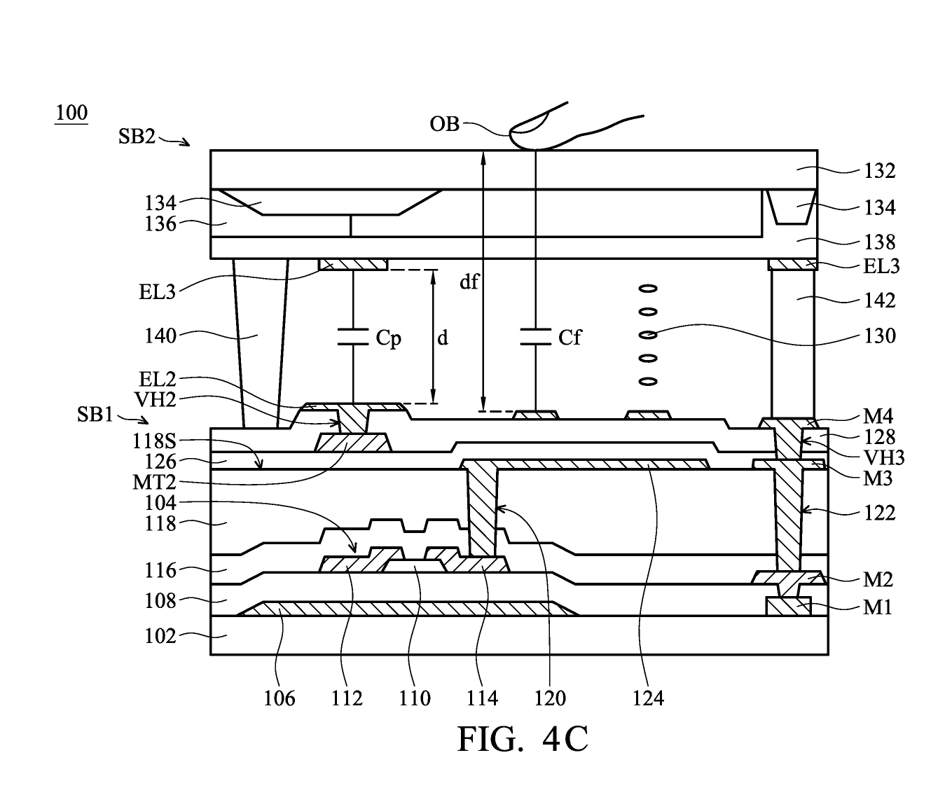

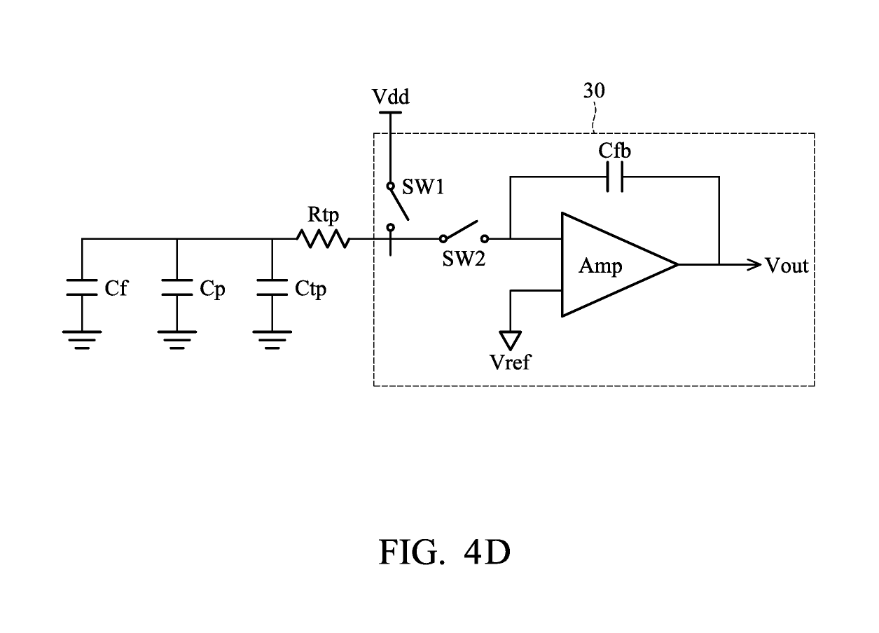

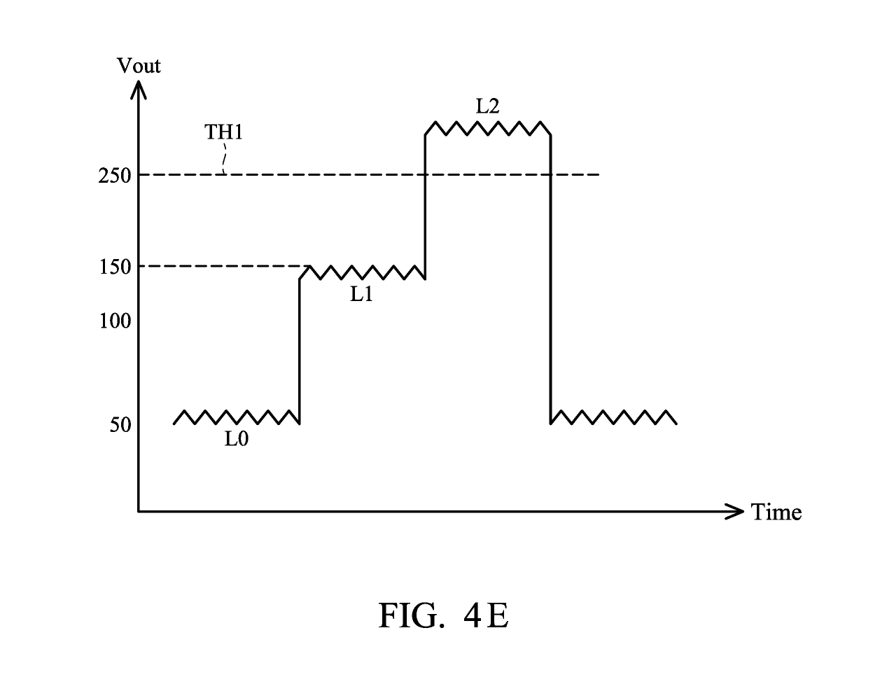

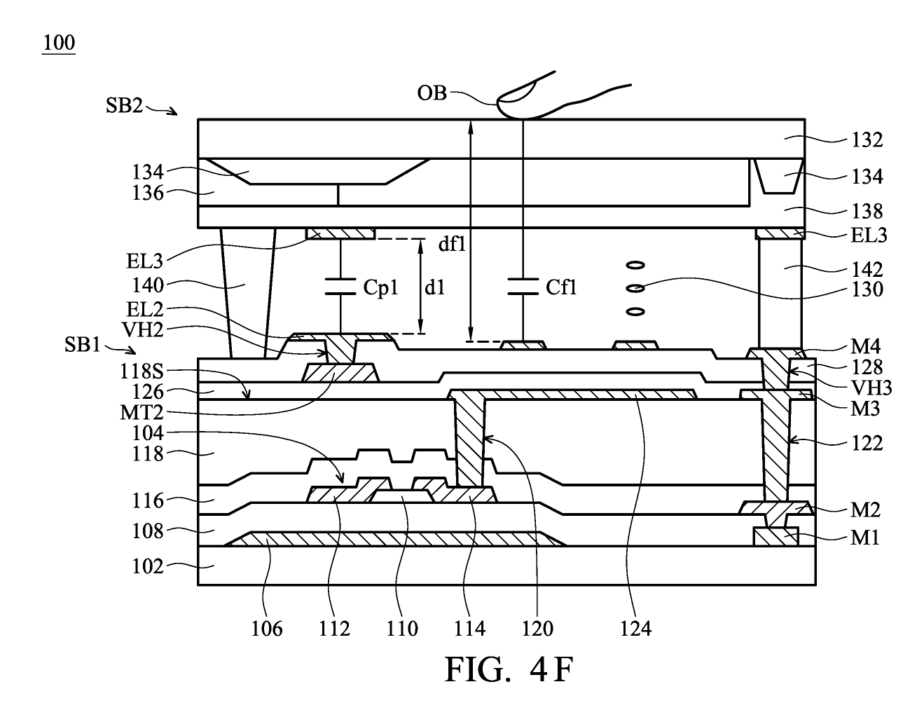

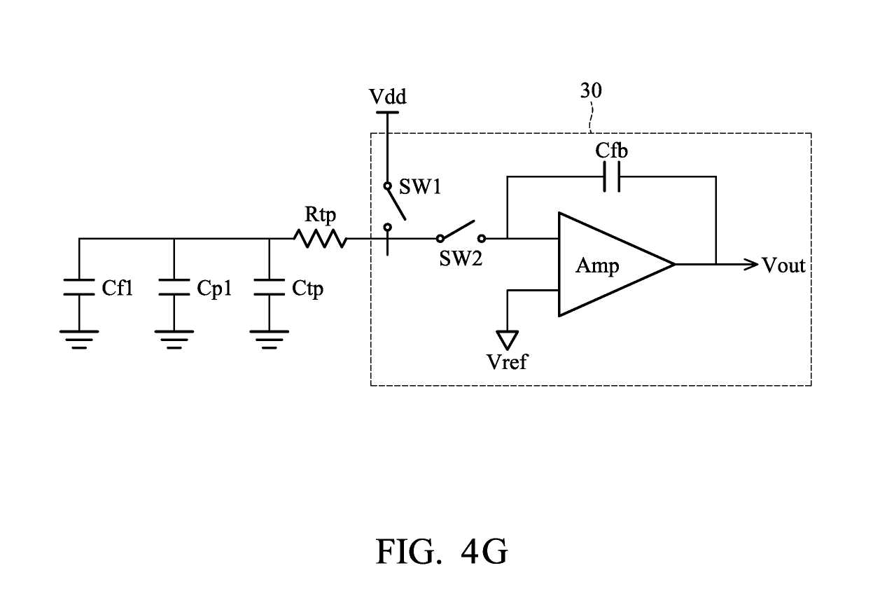

FIG. 4A is a cross-sectional view of a touch display device 100 in accordance with some embodiments of the present disclosure. In some embodiments of the present disclosure, FIG. 4A is a cross-sectional view at the second electrode EL2 in FIG. 2B along the first direction A1. As shown in FIG. 4A, the touch display device 100 includes a display region 101A and a non-display region 101B. The first substrate SB1 may include a substrate 102. The substrate 102 may include, but is not limited to, a transparent substrate, such as a glass substrate, a ceramic substrate, a plastic substrate, or any other suitable transparent substrate. In addition, the first substrate SB1 may include a thin film transistor 104. The thin film transistor 104 can include a gate electrode 106 disposed over the substrate 102 and a gate dielectric layer 108 disposed over the gate electrode 106 and the substrate 102.

The material of the gate electrode 106 may include, but is not limited to, amorphous silicon, poly-silicon, one or more metal, metal nitride, conductive metal oxide, or a combination thereof. The metal may include, but is not limited to, molybdenum, tungsten, titanium, tantalum, platinum, or hafnium. The metal nitride may include, but is not limited to, molybdenum nitride, tungsten nitride, titanium nitride or tantalum nitride. The conductive metal oxide may include, but is not limited to, ruthenium oxide or indium tin oxide. The gate electrode 106 may be formed by the previously described chemical vapor deposition (CVD), sputtering, resistive thermal evaporation, electron beam evaporation, or any other suitable methods. For example, in one embodiment, the amorphous silicon conductive material layer or poly-silicon conductive material layer may be deposited and formed by low-pressure chemical vapor deposition at about 525° C.˜650° C. The thickness of the amorphous silicon conductive material layer or poly-silicon conductive material layer may range from about 1000 Å to 10000 Å.

The material of the gate dielectric layer 108 may include, but is not limited to, silicon oxide, silicon nitride, silicon oxynitride, high-k material, any other suitable dielectric material, or a combination thereof. The high-k material may include, but is not limited to, metal oxide, metal nitride, metal silicide, transition metal oxide, transition metal nitride, transition metal silicide, transition metal oxynitride, metal aluminate, zirconium silicate, zirconium aluminate. For example, the material of the high-k material may include, but is not limited to, LaO, AlO, ZrO, TiO, Ta₂O₅, Y₂O₃, SrTiO₃(STO), BaTiO₃(BTO), BaZrO, HfO₃, HfZrO, HfLaO, HfSiO, HfSiON, LaSiO, AlSiO, HfTaO, HfTiO, HfTaTiO, HfAlON, (Ba,Sr)TiO₃(BST), Al₂O₃, any other suitable high-k dielectric material, or a combination thereof. The gate dielectric layer 108 may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

In addition, a first conductive layer M1 and the gate electrode 106 may be formed at the same time, and the first conductive layer M1 may be positioned at the non-display region 101B of the touch display device 100.

The thin film transistor 104 further includes a semiconductor layer 110 disposed over the gate dielectric layer 108. The semiconductor layer 110 overlaps with the gate electrode 106. A source electrode 112 and a drain electrode 114 are disposed at opposite sides of the semiconductor layer 110 respectively, and overlap with the portions of the semiconductor layer 110 at the opposite sides respectively.

The semiconductor layer 110 may include an element semiconductor which may include silicon, germanium; a compound semiconductor which may include gallium nitride (GaN), silicon carbide, gallium arsenide, gallium phosphide, indium phosphide, indium arsenide and/or indium antimonide; an alloy semiconductor which may include SiGe alloy, GaAsP alloy, AlInAs alloy, AlGaAs alloy, GalnAs alloy, GaInP alloy and/or GaInAsP alloy, InGaZnO, amorphous Si, low temperature poly-silicon; or a combination thereof.

The source electrode 112 and drain electrode 114 may include, but is not limited to, copper, aluminum, molybdenum, tungsten, gold, cobalt, nickel, platinum, titanium, iridium, rhodium, an alloy thereof, a combination thereof, or any other conductive material. For example, the source electrode 112 and drain electrode 114 may include three-layered structure such as Mo/Al/Mo or Ti/Al/Ti. In other embodiments, the source electrode 112 and drain electrode 114 can be a nonmetal conductive material. The material of the source electrode 112 and drain electrode 114 may be formed by chemical vapor deposition (CVD), sputtering, resistive thermal evaporation, electron beam evaporation, or any other suitable method. In some embodiments, the materials of the source electrode 112 and drain electrode 114 may be the same, and the source electrode 112 and drain electrode 114 may be formed by the same deposition steps. However, in other embodiments, the source electrode 112 and drain electrode 114 may be formed by different deposition steps, and the materials of the source electrode 112 and drain electrode 114 may be different from each other.

In addition, a second conductive layer M2 may be formed with the source electrode 112 and the drain electrode 114 at the same time, and can be positioned at the non-display region 101B of the touch display device 100. The second conductive layer M2 is electrically connected to the first conductive layer M1.

Still referring to FIG. 4A, the first substrate SB1 further includes a first insulating layer 116 disposed over the thin film transistor 104 and gate dielectric layer 108. The material of the first insulating layer 116 may include, but is not limited to, silicon nitride, silicon oxide, or silicon oxynitride. The first insulating layer 116 may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

Subsequently, a second insulating layer 118 may be optionally disposed over the first insulating layer 116. The material of the second insulating layer 118 may include, but is not limited to, organic insulating materials (such as photosensitive resins) or inorganic insulating materials (such as silicon nitride, silicon oxide, silicon oxynitride, silicon carbide, aluminum oxide, or a combination thereof). In addition, the second insulating layer 118 and first insulating layer 116 may be etched by two etching steps respectively to form two via holes 120 and 122. The via hole 120 extend downward from the top surface 118S of the second insulating layer 118 to the drain electrode 114, and exposes the drain electrode 114. The via hole 122 extends downward from the top surface 118S of the second insulating layer 118 to the second conductive layer M2, and exposes the second conductive layer M2.

Still referring to FIG. 4A, the touch display device 100 further includes a pixel electrode 124 disposed over the second insulating layer 118. The pixel electrode 124 extends into the via hole 120 and is electrically connected to the transistor 104. In addition, the display device 100 further includes a third conductive layer M3 disposed over the second insulating layer 118. The third conductive layer M3 is positioned at the non-display region 101B of the touch display device 100, and is electrically connected to the second conductive layer M2 through the via hole 122.

The materials of the third conductive layer M3 and pixel electrode 124 may be the same, and the third conductive layer M3 and pixel electrode 124 may be formed by the same deposition, photolithography and etching steps. The material of the third conductive layer M3 and pixel electrode 124 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide.

Still referring to FIG. 4A, the display device 100 further includes a third insulating layer 126 disposed over the second insulating layer 118 and covering the pixel electrode 124. The material of the third insulating layer 126 may include, but is not limited to, silicon nitride, silicon oxide, or silicon oxynitride.

Still referring to FIG. 4A, the display device 100 further includes a metal line MT2 disposed over the third insulating layer 126. The metal line MT2 may include, but is not limited to, copper, aluminum, molybdenum, tungsten, gold, cobalt, nickel, platinum, titanium, iridium, rhodium, an alloy thereof, a combination thereof, or any other conductive material. For example, the metal line MT2 may include a three-layered structure such as Mo/Al/Mo or Ti/Al/Ti. In other embodiments, the metal line MT2 can be a nonmetal conductive material. The material of the metal line MT2 may be formed by chemical vapor deposition (CVD), sputtering, resistive thermal evaporation, electron beam evaporation, or any other suitable method.

Still referring to FIG. 4A, the display device 100 further includes a fourth insulating layer 128 disposed over the third insulating layer 126 and covering the metal line MT2. The material of the fourth insulating layer 128 may include, but is not limited to, silicon nitride, silicon oxide, or silicon oxynitride.

Still referring to FIG. 4A, the touch display device 100 further includes a second electrode EL2 that is disposed over the fourth insulating layer 128 and is electrically connected to the metal line MT2. In addition, a fourth conductive layer M4 may be disposed over the fourth insulating layer 128. The fourth conductive layer M4 is positioned at the non-display region 101B of the touch display device 100, and is electrically connected to the third conductive layer M3. The materials of the fourth conductive layer M4 and second electrode EL2 may be the same, and the fourth conductive layer M4 and second electrode EL2 may be formed by the same deposition, photolithography and etching steps

The second electrode EL2 may be patterned to form a slit and may be used as the common electrode and/or the touch electrode of the touch display device 100. In addition, the second electrode EL2 is connected to the metal line MT2 at the underlayer through the via hole VH2. In addition, the fourth conductive layer M4 is connected to the third conductive layer M3 through another via hole VH3.

The material of the fourth conductive layer M4 and second electrode EL2 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide.

In addition, still referring to FIG. 4A, the display device 100 further includes a second substrate SB2 disposed opposite the first substrate SB1 and a display medium 130 disposed between the first substrate SB1 and the second substrate SB2.

The display device 100 may include, but is not limited to, a touch liquid-crystal display such as a thin film transistor liquid-crystal display. The liquid-crystal display may include, but is not limited to, a twisted nematic (TN) liquid-crystal display, a super twisted nematic (STN) liquid-crystal display, a double layer super twisted nematic (DSTN) liquid-crystal display, a vertical alignment (VA) liquid-crystal display, an in-plane switching (IPS) liquid-crystal display, a cholesteric liquid-crystal display, a blue phase liquid-crystal display, fringe field switching liquid-crystal display, or any other suitable liquid-crystal display.

In some embodiments of the present disclosure, the display medium 130 may be a liquid-crystal material. The liquid-crystal material may include, but is not limited to, nematic liquid crystal, smectic liquid crystal, cholesteric liquid crystal, blue phase liquid crystal, or any other suitable liquid-crystal material. In some other embodiments, the display medium 130 may be an organic light-emitting diode.

In some embodiments, the second substrate SB2 can be a color filter substrate. In particular, the second substrate SB2, which serves as a color filter substrate, may include a substrate 132, a light-shielding layer 134 disposed over the substrate 132, a color filter layer 136 disposed over the light-shielding layer 134 and the substrate 132, and a protection layer 138 covering the light-shielding layer 134 and the color filter layer 136.

The substrate 132 may include a transparent substrate such as a glass substrate, a ceramic substrate, a plastic substrate, or any other suitable transparent substrate. The light-shielding layer 134 may be, but is not limited to, black photoresist, black printing ink, or black resin. The color filter layer 136 may include a red color filter layer, a green color filter layer, a blue color filter layer, or any other suitable color filter layer.

The display device 100 further includes a spacer 140 disposed between the first substrate SB1 and second substrate SB2. The spacer 140 is the main structure used to space the first substrate SB1 apart from the second substrate SB2 to prevent the first substrate SB1 from touching the second substrate SB2 when the display device 100 is pressed or touched.

Still referring to FIG. 4A, according to some embodiments of the present disclosure, a third electrode EL3 is disposed over the protection layer 138 of the second substrate SB2. The material of the third electrode EL3 may include, but is not limited to, transparent conductive material or metal material. The transparent conductive material may include, but is not limited to, indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide. The metal material may include, but is not limited to, copper, aluminum, molybdenum, tungsten, gold, cobalt, nickel, platinum, titanium, iridium, rhodium, an alloy thereof, a combination thereof, or any other conductive material.

In some embodiments of the present disclosure, the third electrode EL3 is disposed between the light-shielding layer 134 and the second electrode EL2, and is positioned at the light-shielding region formed by the light-shielding layer 134. However, the present disclosure is not limited thereto. The third electrode EL3 may be disposed between the light-shielding layer 134 and the second substrate SB2 or between the light-shielding layer 134 and the protection layer 138.

Afterward, the first substrate SB1 and the second substrate SB2 are assembled, and the capacitance Cp is formed between the second electrode EL2 and the third electrode EL3. The capacitance Cp may be changed according to the distance change between the electrodes due to pressing. In addition, as shown in FIG. 4A, according to some embodiments of the present disclosure, the second electrode EL2 is disposed between the pixel electrode 124 and the third electrode EL3.

In some embodiments of the present disclosure, the touch display device 100 further includes a connecting element 142 positioned at the non-display region 101B of the touch display device 100. The third electrode EL3 is electrically connected to the first substrate SB1 through the connecting element 142, the fourth conductive layer M4, the third conductive layer M3, the second conductive layer M2 and the first conductive layer M1.

The connecting element 142 may be Au ball, an anisotropic conductive film (ACF), silver glue, or any other suitable conductive material. The voltage of the third electrode EL3 may be set by the connecting element 142. For example, the voltage of the third electrode EL3 may be the voltage of the aforementioned first signal (such as the common electrode voltage), the voltage of the second signal (such as the sensing signal voltage), ground voltage, or any other specific voltage. Alternatively, in some other embodiments, the touch display device 100 does not include the connecting element 142, and the voltage of the third electrode EL3 is floating.

FIG. 4B is an equivalent circuit diagram of the touch display device 100 in FIG. 4A. In this embodiment, Rtp is the equivalent resistance of the metal line MT2, and Ctp is the equivalent capacitance of the metal line MT2 (i.e. The total capacitance formed between the metal line MT2 and other electrodes/metal layers). And a capacitance Cp is formed at the portion of the metal line MT2 where the metal line MT2 is electrically connected to the second electrode EL2. The controller 30 includes the first switch SW1, the second switch SW2, the amplifier Amp and the feedback capacitance Cfb. The first switch SW1 and the second switch SW2 are on and off alternately in order to charge and discharge the capacitance Ctp and Cp. In particular, one end of the first switch SW1 is coupled to power source Vdd, when the first switch SW1 is on, the second switch SW2 is off, and the power source Vdd charge the capacitance Ctp and Cp. Conversely, when the second switch SW2 is on, the first switch SW1 is off, and the charge in the capacitance Ctp and Cp is output to one input end of the amplifier Amp. Another input end of the amplifier Amp can be, for example, coupled to the reference voltage Vref. The input end and output end of the amplifier Amp are coupled by the feedback capacitance Cfb according to the requirement of circuit stability and bandwidth. The amplifier Amp may respond to the signal from the metal line MT2 and generate the output sensing signal Vout. When no touch event happens, the output sensing signal Vout may be represented as follows:

$$Vout = \frac{Ctp + Cp}{Cfb} \times ( Vdd - Vref ) \times n \qquad Equation 1$$

n is the number of times the sensing cycle is repeated.

Next, referring to FIG. 4C, FIG. 4C is a schematic figure when the planar-touch event happens in the touch display device 10, but the press-touch event does not happen in accordance with some embodiments of the present disclosure.

As shown in FIG. 4C, when the object OB (for example, a finger, a stylus or any other object which may be used to operate the touching operation) touches the touch display device 100, the inductive capacitance Cf is generated between the object OB and the second electrode EL2 in the touch display device 100. FIG. 4D is an equivalent circuit diagram of the touch display device in FIG. 4C. As shown in FIG. 4D, the inductive capacitance Cf is generated by the metal line MT2. Therefore, when only the planar-touch event happens, the output sensing signal Vout may be represented as follows:

$$Vout = \frac{Ctp + Cp + Cf}{Cfb} \times ( Vdd - Vref ) \times n \qquad Equation 2$$

As shown in the equation 2, when the object OB touches the touch display device 100, the output sensing signal Vout increases. In other words, the output sensing signal Vout in the equation 2 is greater than the output sensing signal Vout in the equation 1.

FIG. 4E is a wave shape figure of the output sensing signal in accordance with some embodiments of the present disclosure. In some embodiments of the present disclosure, as shown in FIG. 4E, the controller set a first threshold value TH1 in order to determine whether the press-touch event happens or not. In some embodiments of the present disclosure, the first threshold value TH1 can, for example, correspond to the signal value 300.

When the touch event does not happen, the value of the output sensing signal Vout is L0, and L0 is about 50 (here the value of the output sensing signal Vout is merely to represent the relative relation of the signals, therefore the value does not have units). When only the planar-touch event happens (not pressed heavily), the value of the output sensing signal Vout is L1, and L1 is about 150. As shown in FIG. 4E, L1 is not greater than the first threshold value TH1 (for example corresponding to the signal value 300). Therefore, the controller may determine that the press-touch event does not happen.

In addition, it should be noted that the capacitance value of the inductive capacitance Cf is inversely related to the distance df between the object OB and the second electrode EL2. That is to say, when the object OB presses the touch display device and lets the distance df decrease, the capacitance value of the inductive capacitance Cf increases, and the output sensing signal Vout also increases.

In addition, the capacitance value of the inductive capacitance Cp is inversely related to the distance d between the second electrode EL2 and the third electrode EL3. That is to say, when the object OB presses the touch display device and lets the distance d decrease, the capacitance value of the inductive capacitance Cp increases, and the output sensing signal Vout also increases.

Next, FIG. 4F is a cross-sectional view of a touch display device 100 in accordance with some embodiments of the present disclosure. When the object OB heavily presses the touch display device and make the original gap d and df decreases to gap d1 and df1, the distance between the second electrode EL2 and the third electrode EL3 decreases. Since the distance between the second electrode EL2 and the third electrode EL3 decreases, the capacitance value of the inductive capacitance Cp increases to the capacitance Cpl. Since the distance between the object OB and the second electrode EL2 decreases, the capacitance value of the inductive capacitance Cf increases to the capacitance Cf1. FIG. 4G is an equivalent circuit diagram of the touch display device in FIG. 4F. Therefore, when a press-touch event happens, the output sensing signal Vout may be represented as follows:

$$Vout = \frac{Ctp + Cp 1 + Cf 1}{Cfb} \times ( Vdd - Vref ) \times n \qquad Equation 3$$

In some embodiments of the present disclosure, when a press-touch event happens, the value of the output sensing signal Vout is L2, and is about 300. As shown in FIG. 4E, L2 is greater than the first threshold value TH1 (for example corresponding to the signal value 250). Therefore, the controller may determine that a press-touch event is happening.

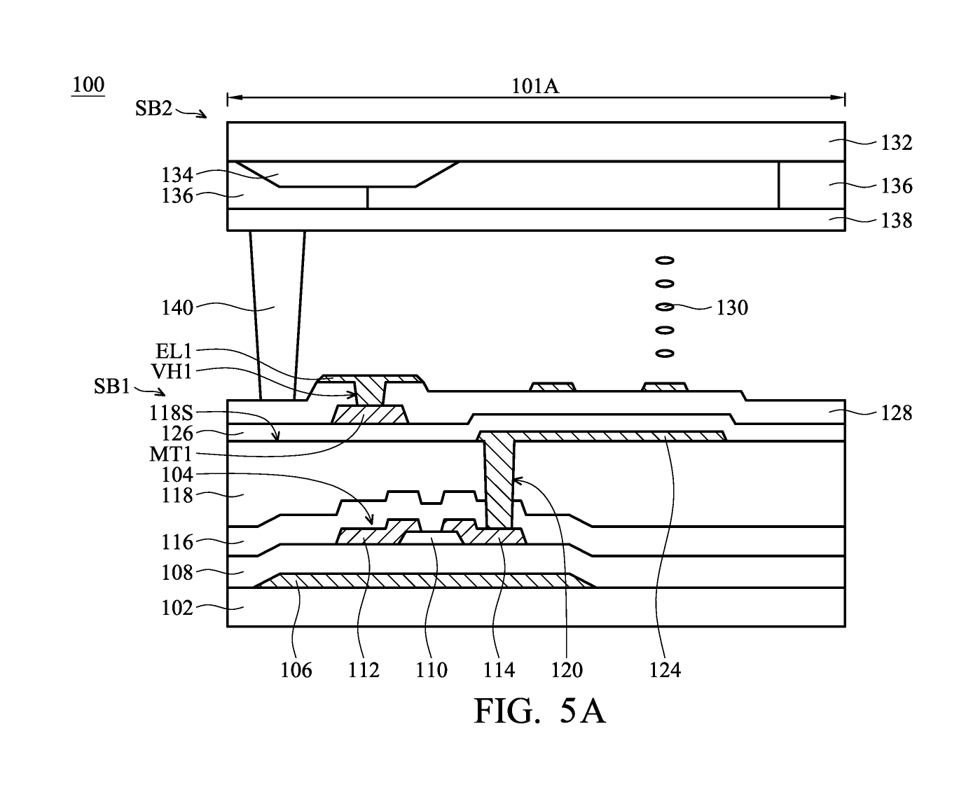

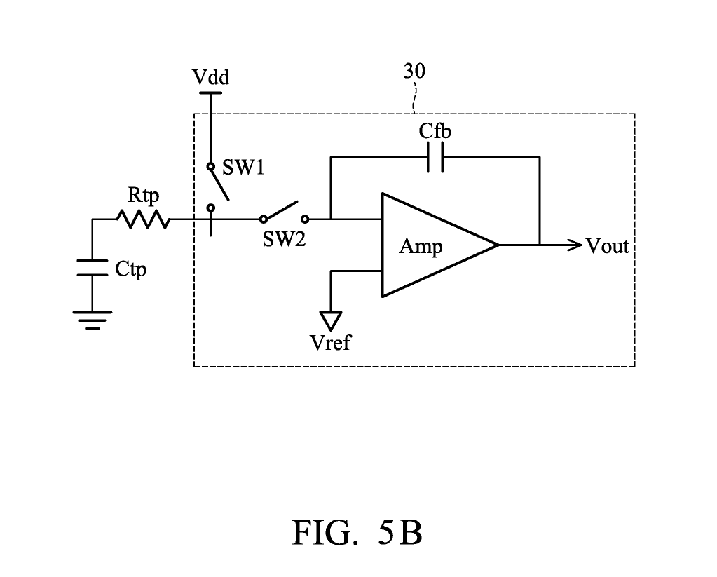

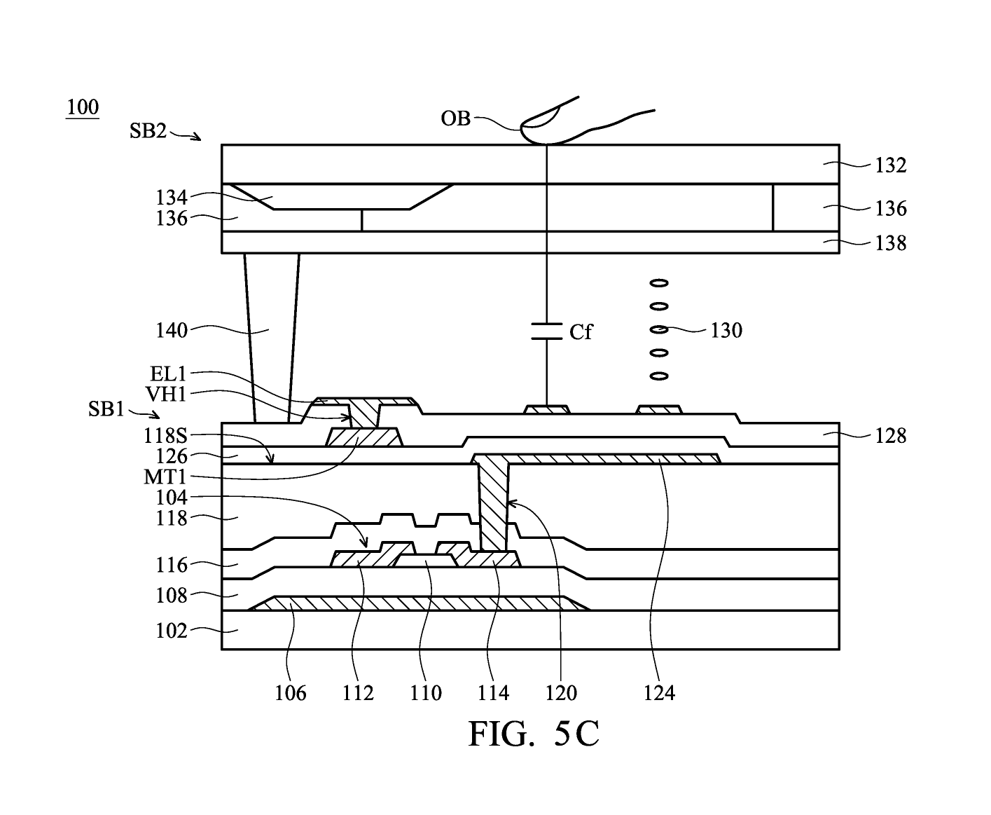

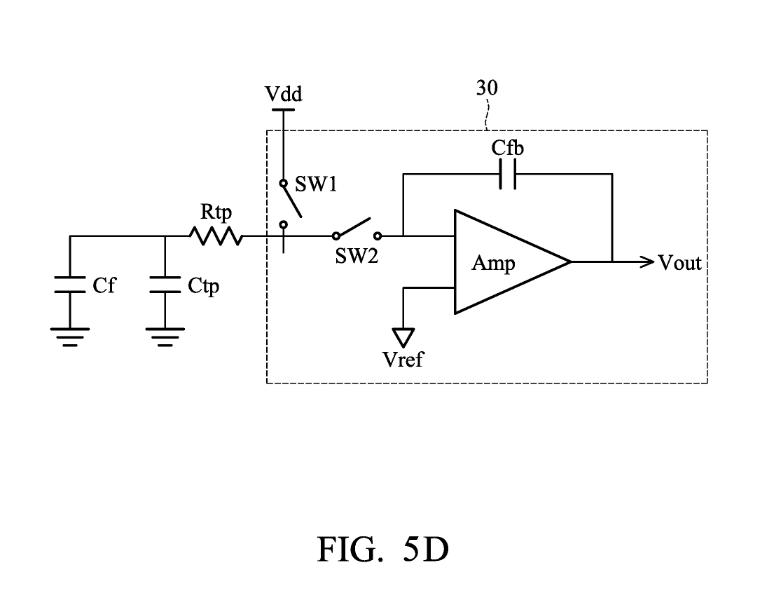

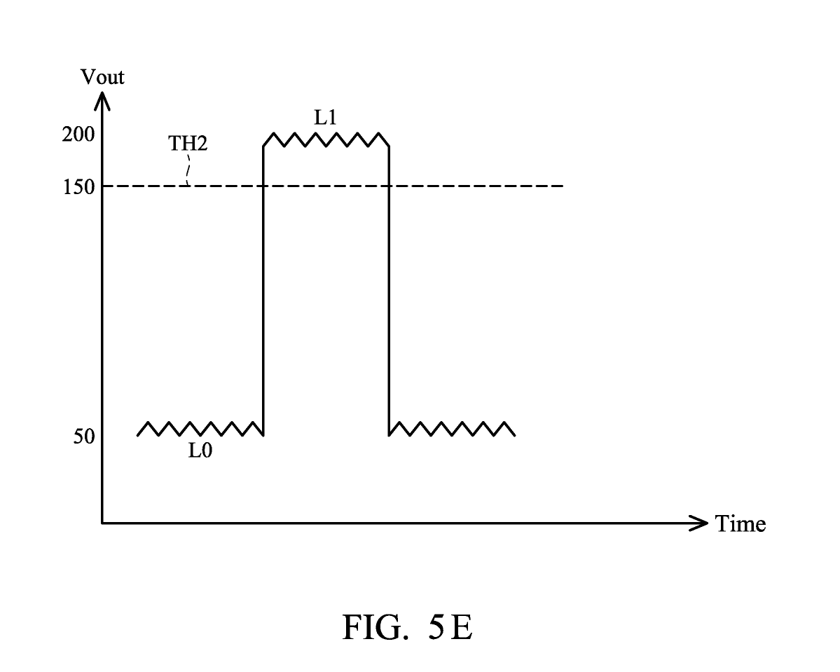

FIG. 5A is a cross-sectional view of a touch display device 100 when no touch event happens in accordance with some embodiments of the present disclosure. In some embodiments of the present disclosure, FIG. 5A is a cross-sectional view at the first electrode EL1 in FIG. 2B along the first direction A1. As shown in FIG. 5, according to some embodiments of the present disclosure, no third electrode EL3 is disposed in the region of the second substrate SB2 to which the first electrode EL1 corresponds. Therefore, the metal line MT1 does not have the capacitance Cp generated by the third electrode EL3.

In addition, as shown in FIG. 5A, according to some embodiments of the present disclosure, the first electrode EL1 is disposed between the pixel electrode 124 and the third electrode EL3.

FIG. 5B is an equivalent circuit diagram of the touch display device in FIG. 5A. When no touch event occurs, the output sensing signal Vout may be represented as follows:

$$Vout = \frac{Ctp}{Cfb} \times ( Vdd - Vref ) \times n \qquad Equation 4$$

As shown in FIG. 5C, when the object OB (for example, a finger, a stylus or any other object which may be used to operate the touching operation) touches the touch display device 100, an inductive capacitance Cf is generated between the object OB and the second electrode EL2 in the touch display device 100. FIG. 5D is an equivalent circuit diagram of the touch display device in FIG. 5C. As shown in FIG. 5D, the inductive capacitance Cf is generated by the metal line MT1. Therefore, when only the planar-touch event happens, the output sensing signal Vout may be represented as follows:

$$Vout = \frac{Ctp + Cf}{Cfb} \times ( Vdd - Vref ) \times n \qquad Equation 5$$

As shown in the equation 5, when the object OB touches the touch display device 100, the output sensing signal Vout increases. In other words, the output sensing signal Vout in the equation 5 is greater than the output sensing signal Vout in the equation 4.

FIG. 5E is a wave shape figure of the output sensing signal in accordance with some embodiments of the present disclosure. In some embodiments of the present disclosure, as shown in FIG. 5E, the controller sets a second threshold value TH2 in order to determine whether the planar-touch event happens or not. In some embodiments of the present disclosure, the second threshold value TH2 corresponds to the signal value 150.

When the planar-touch event does not happen, the value of the output sensing signal Vout is L0, and L0 is about 50 (here the value of the output sensing signal Vout is merely to represent the relative relationship of the signals, and therefore the value does not have units). When only the planar-touch event happens (not pressed heavily), the value of the output sensing signal Vout is L1, and L1 is about 200. As shown in FIG. 5E, L1 is greater than the second threshold value TH2 (for example corresponding to the signal value 150). Therefore, the controller may determine that a press-touch event is happening.

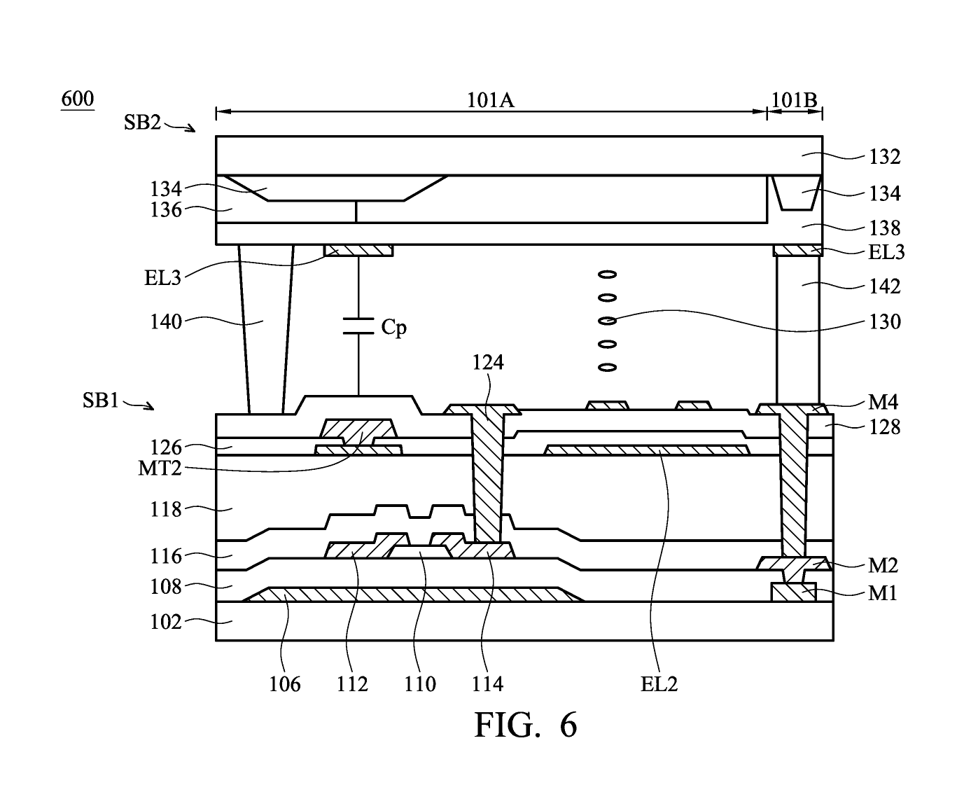

FIG. 6 is a cross-sectional view of a touch display device 600 in accordance with some other embodiments of the present disclosure. The difference between the touch display device 600 and the touch display device 100 is that the touch display device 600 includes a pixel electrode 124 that is formed over the common electrode (for example, the second electrode EL2 and/or the first electrode EL1) (Top pixel structure). As shown in FIG. 6, the pixel electrode 124 is formed between the first electrode ELL the second electrode EL2 and the third electrode EL3, and the pixel electrode 124 is electrically connected to the thin film transistor 104 of the first substrate SB1. This structure may improve the transmittance. The signal operation and touch determination of the touch display device 600 is similar to the aforementioned embodiments, and the description thereof is not repeated again.

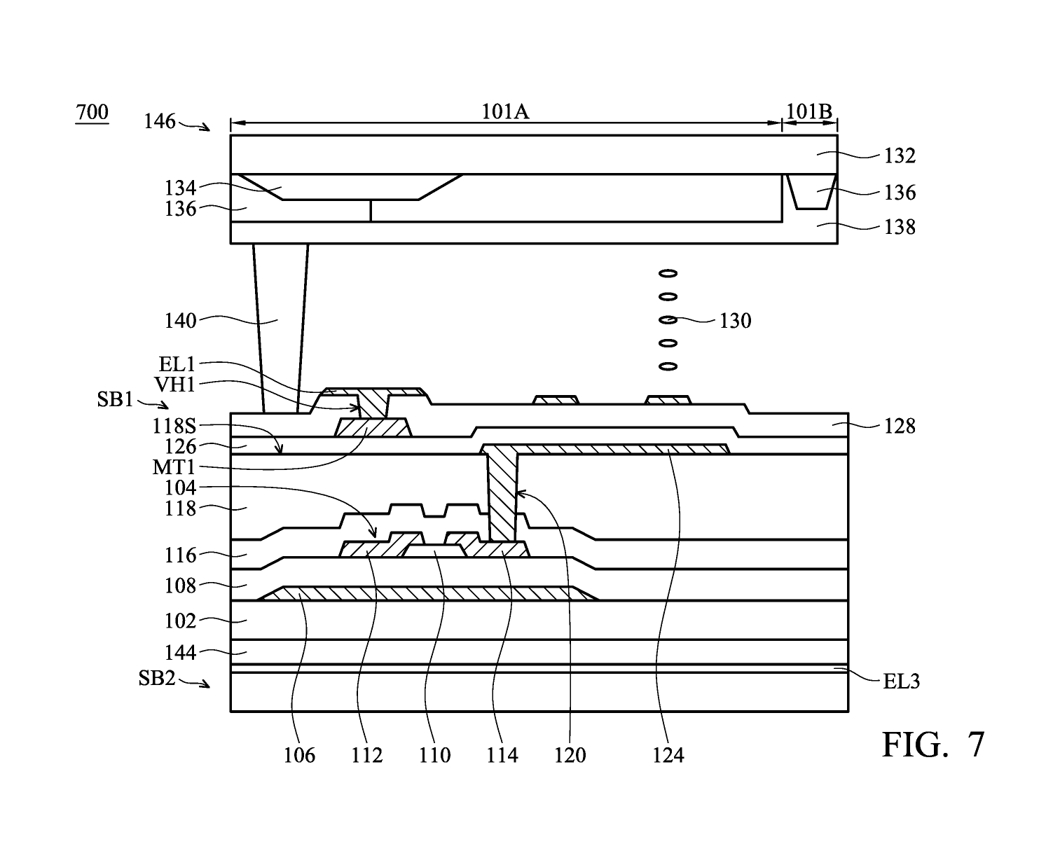

FIG. 7 is a cross-sectional view of a touch display device 700 in accordance with some other embodiments of the present disclosure. The difference between the touch display device 700 and the touch display device 100 is that the second substrate SB2 of the touch display device 700 is a backlight unit, and is disposed under the first substrate SB1. In addition, in some embodiments of the present disclosure, the third electrode EL3 may be patterned to have a strip shape. However, in some other embodiments of the present disclosure, the third electrode EL3 disposed over the backlight unit may be an entire plane.

In this embodiment, the material of the third electrode EL3 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide.

In addition, in some embodiments, a dielectric layer 144 is disposed between the third electrode EL3 and the first substrate SB1. In some embodiments of the present disclosure, the dielectric layer 144 includes an optical glue (optically clear adhesive/resin) layer or an air layer.

In addition, in some embodiments, the display device 100 may also include a color filter substrate 146. The color filter substrate 146 and the second substrate SB2 which serves as the backlight unit are disposed at opposite sides of the first substrate SB1. For example, the color filter substrate 146 is disposed over the upper side of the first substrate SB1, whereas the second substrate SB2 is disposed over the lower side of the first substrate SB1.

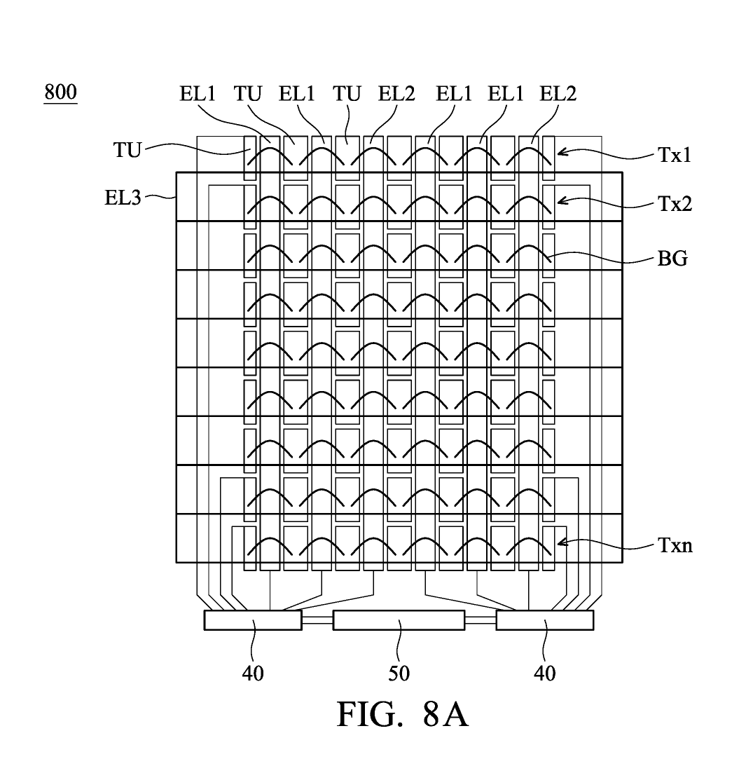

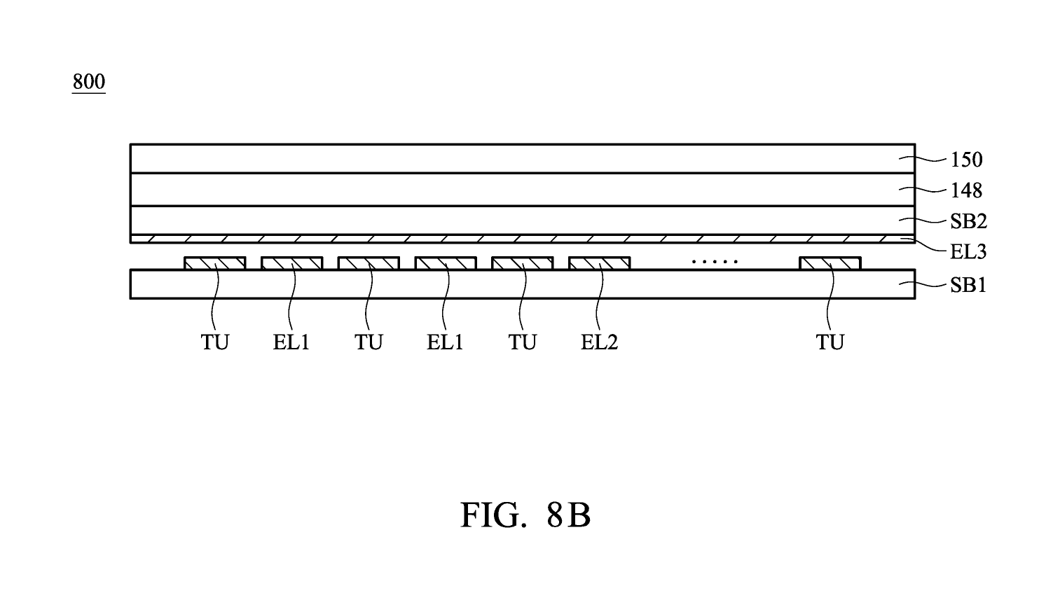

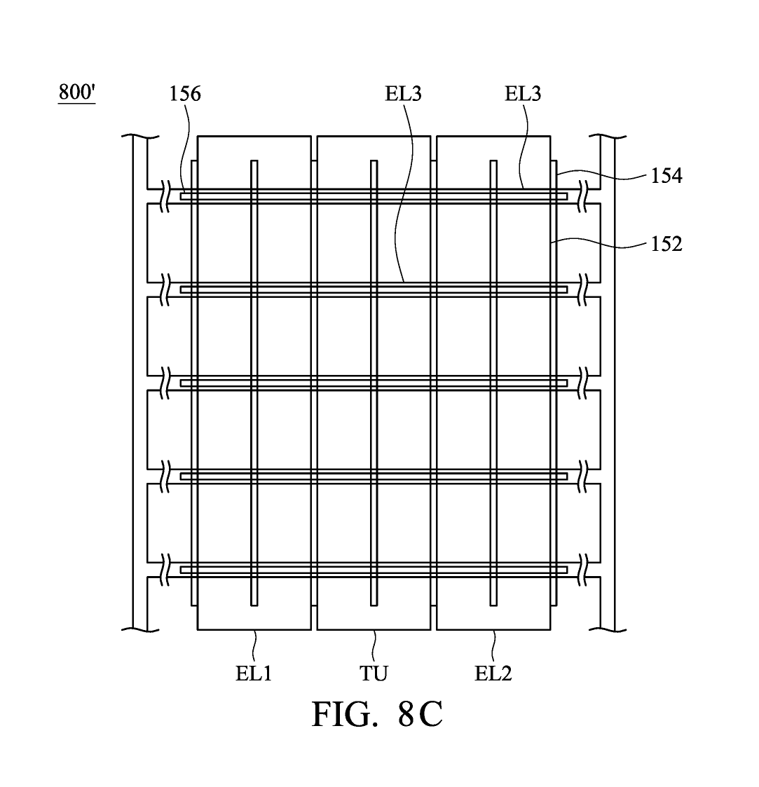

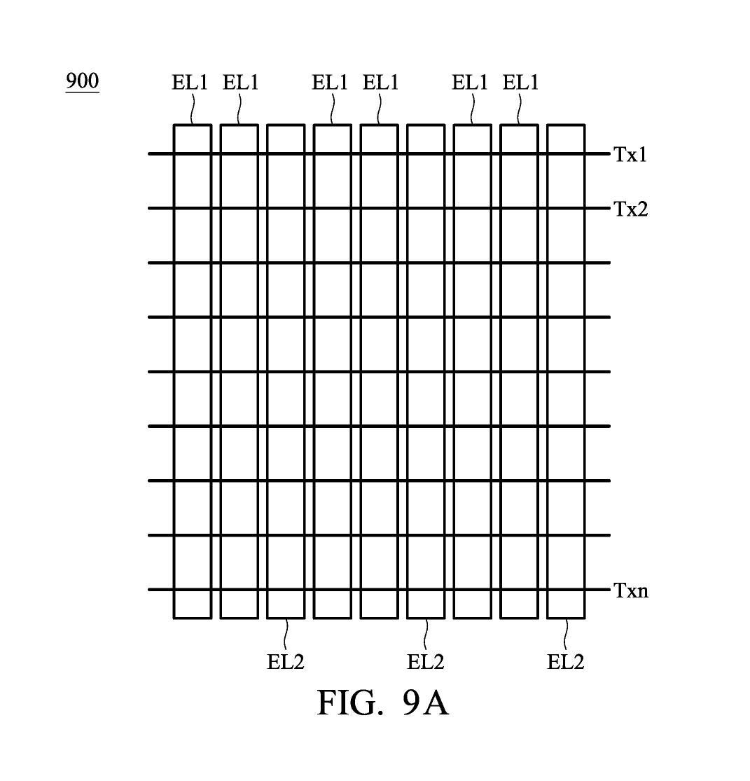

FIG. 8A is a top view of a touch display device 800 in accordance with some other embodiments of the present disclosure. FIG. 8B is a cross-sectional view of the touch display device 800 in accordance with some other embodiments of the present disclosure. In the embodiments shown in FIGS. 8A-8B, the touch display device 100 further includes a plurality of transmission electrodes Tx1˜Txn disposed over the first substrate SB1. The transmission electrodes Tx1˜Txn intersect the first electrode EL1 and the second electrode EL2, and are connected to the controller 40. In some embodiments of the present disclosure, the controller 40 is a touch control unit. In addition, the controller 40 may be further connected to another controller 50, and the controller 50 may be a display control unit, for example.

In addition, as shown in FIG. 8A, in accordance with some other embodiments of the present disclosure, each transmission electrode Tx1˜Txn includes a plurality of transmission electrode units TU and a plurality of bridge structures BG over the first substrate SB1. Each of the bridge structures BG is electrically connected to two adjacent transmission electrode units TU, so that the plurality of transmission electrode units TU are electrically connected to each other to form a transmission electrode.

In this embodiment, the transmission electrodes Tx1˜Txn, the first electrode EL1 and the second electrode EL2 are configured by a mutual-capacitive in-cell structure. In some embodiments of the present disclosure, the first electrode EL1 and the second electrode EL2 are the receiving electrodes.

In this embodiment, the first electrode EL1 and the second electrode EL2, which serve as the receiving electrodes, are juxtaposed and configured in multiple columns. The transmission electrodes Tx1˜Txn are juxtaposed and configured in multiple rows. In addition, as shown in FIGS. 8A-8B, according to some embodiments of the present disclosure, two first electrodes EL1 and one second electrode EL2 are arranged alternately. However, in some other embodiments of the present disclosure, one first electrode EL1 and one second electrode EL2 are arranged alternately.

As shown in FIG. 8B, according to some embodiments of the present disclosure, a dielectric layer 148 (for example an optical glue layer or an air layer) is disposed over the second substrate SB2 of the touch display device 800, and a protective glass 150 is disposed over the dielectric layer 148.

It should be noted that the exemplary embodiment set forth in FIG. 8A is merely for the purpose of illustration. Although in the exemplary embodiment set forth in FIG. 8A, one transmission electrode (or one transmission electrode unit TU) merely corresponds to one third electrode EL3, one transmission electrode (or one transmission electrode unit TU) may also correspond to another amount of third electrodes EL3, as shown in the exemplary embodiment set forth in FIG. 8C. This will be described in detail in the following description. Therefore, the present disclosure is not limited to the exemplary embodiment shown in FIG. 8A.

FIG. 8C is a top view of a touch display device 800′ in accordance with some other embodiments of the present disclosure. As shown in FIG. 8C, according to some embodiments of the present disclosure, one transmission electrode unit TU may cover multiple columns of the sub-pixels 152, multiple columns of the data lines 154, and multiple rows of gate lines (or the scan lines) 156. For example, in some embodiments of the present disclosure, one transmission electrode unit TU may cover 2 to 30 columns of the sub-pixels 152, and 2 to 30 multiple columns of the data lines 154, for example may cover 10 to 20 columns of the sub-pixels 152, and 10 to 20 multiple columns of the data lines 154. In addition, in some embodiments of the present disclosure, one transmission electrode (or one transmission electrode unit TU) may correspond to 5 to 30 rows of gate lines (or the scan lines) 156 and the third electrodes EL3, for example 10 to 20 rows of gate lines (or the scan lines) 156 and the third electrodes EL3.

In addition, as shown in FIG. 8C, according to some embodiments of the present disclosure, one first electrode EL1 may cover multiple columns of the sub-pixels 152, multiple columns of the data lines 154, and multiple rows of gate lines (or the scan lines) 156 and the third electrodes EL3. For example, in some embodiments of the present disclosure, one first electrode EL1 may cover 2 to 30 columns of the sub-pixels 152, and 2 to 30 multiple columns of the data lines 154, for example cover 10 to 20 columns of the sub-pixels 152, and 10 to 20 multiple columns of the data lines 154. In addition, in some embodiments of the present disclosure, one first electrode EL1 may correspond to 5 to 30 rows of gate lines (or the scan lines) 156 and the third electrodes EL3, for example 10 to 20 rows of gate lines (or the scan lines) 156 and the third electrodes EL3.

In addition, as shown in FIG. 8C, according to some embodiments of the present disclosure, one second electrode EL2 may also cover multiple columns of the sub-pixels 152, multiple columns of the data lines 154, and multiple rows of gate lines (or the scan lines) 156. For example, in some embodiments of the present disclosure, one second electrode EL2 may cover 2 to 30 columns of the sub-pixels 152, and 2 to 30 multiple columns of the data lines 154, for example cover 10 to 20 columns of the sub-pixels 152, and 10 to 20 multiple columns of the data lines 154. In addition, in some embodiments of the present disclosure, one second electrode EL2 may correspond to 5 to 30 rows of gate lines (or the scan lines) 156 and the third electrodes EL3, for example 10 to 20 rows of gate lines (or the scan lines) 156 and the third electrodes EL3.

FIG. 9A is a top view of a touch display device 900 in accordance with some other embodiments of the present disclosure. FIG. 9B is a cross-sectional view of a touch display device 900 in accordance with some other embodiments of the present disclosure. As shown in FIGS. 9A-9B, in accordance with some embodiments, the third electrode EL3 disposed over the second substrate SB2 includes a plurality of transmission electrodes Tx1˜Txn, and the plurality of transmission electrodes Tx1˜Txn intersect the first electrode EL1 and the second electrode EL2.

In addition, in this embodiment, no transmission electrode is disposed between the first electrode EL1 and the second electrode EL2.

In this embodiment, the transmission electrodes Tx1˜Txn, the first electrode EL1 and the second electrode EL2 are configured by a mutual-capacitive in-cell structure. In some embodiments of the present disclosure, the first electrode EL1 and the second electrode EL2 are the receiving electrodes. However, the present disclosure is not limited thereto. In some embodiments of the present disclosure, the third electrode EL3 disposed over the second substrate SB2 may include a plurality of receiving electrodes, and the first electrode EL1 and the second electrode EL2 can be the transmission electrodes.

In some embodiments of the present disclosure, the first electrode EL1 and the second electrode EL2, which serve as the receiving electrodes, are arranged in multiple columns, and the transmission electrodes Tx1˜Txn are arranged in multiple rows. In addition, as shown in FIGS. 9A-9B, according to some embodiments of the present disclosure, two first electrodes EL1 and one second electrode EL2 are arranged alternately. However, in some other embodiments of the present disclosure, one first electrode EL1 and one second electrode EL2 can be arranged alternately.

As shown in FIG. 9B, according to some embodiments of the present disclosure, a dielectric layer 148 (for example an optical glue layer or an air layer) is disposed over the second substrate SB2 of the touch display device 900, and a protective glass 150 is disposed over the dielectric layer 148.

FIG. 9C is an enlarged figure of one first electrode EL1 in FIG. 9A. As shown in FIG. 9C, according to some embodiments of the present disclosure, one first electrode EL1 may cover multiple columns of the sub-pixels 152, multiple columns of the data lines 154, multiple rows of gate lines (or the scan lines) 156, and multiple rows of the transmission electrode. For example, in some embodiments of the present disclosure, one first electrode EL1 may cover 3 to 30 columns of the sub-pixels 152, and 4 to 30 multiple columns of the data lines 154, for example cover 10 to 20 columns of the sub-pixels 152, and 10 to 20 multiple columns of the data lines 154.

In addition, according to some embodiments of the present disclosure, one first electrode EL1 may cover 3 to 30 rows of gate lines 156 and the transmission electrodes, for example 10 to 20 rows of gate lines 156 and the transmission electrodes. In addition, in some embodiments of the present disclosure, the configuration of the second electrode EL2 can be the same as or similar to the configuration of the first electrode EL1.

In summary, according to some embodiments, on a first substrate, a first electrode is provided to detect a planar-touch event and a second electrode is provided to detect a press-touch event. With this configuration, the touch display device does not need an additional pressure-sensing unit to detect the press-touch event, and the controller does not need a specific signal channel to process the pressure-sensing signal from the pressure-sensing structure.

In addition, in some embodiments of the present disclosure, the first electrode used to detect the planar-touch event and the second electrode used to detect the press-touch event are electrically isolated from each other. Therefore, the first electrode and the second electrode may respectively transmit the planar-touch sensing signal and the press-touch sensing signal to the controller through independent and different signal channels. Therefore, the controller of some embodiments of the present disclosure may determine if the planar-touch event happens by the planar-touch sensing signal alone, and may determine if the press-touch event happens by the press-touch sensing signal alone.

In addition, since the touch display device of some embodiments of the present disclosure may determine if the press-touch event happens alone, the press sensitivity of the touch display device of some embodiments of the present disclosure may be more accurate, and multi-point and multi-stage press sensing may be realized.

In addition, it should be noted that the drain and source mentioned above in the present disclosure are switchable since the definition of the drain and source is related to the voltage connecting thereto.

Note that the above element sizes, element parameters, and element shapes are not limitations of the present disclosure. Those skilled in the art can adjust these settings or values according to different requirements. It should be understood that the touch display device of the present disclosure is not limited to the configurations of FIGS. 1A to 9C. The present disclosure may merely include any one or more features of any one or more embodiments of FIGS. 1A to 9C. In other words, not all of the features shown in the figures should be implemented in the touch display device of the present disclosure.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and operations described in the specification. As one of ordinary skill in the art will readily appreciate from the disclosure of the present disclosure, processes, machines, manufacture, compositions of matter, means, methods, or operations, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or operations.

What is claimed is:

1. A touch display device, comprising:
a first substrate, comprising a plurality of pixels and a plurality of thin film transistors;
a second substrate disposed opposite to the first substrate;
a plurality of first electrodes disposed over the first substrate and used to detect a planar-touch event;
a second electrode disposed over the first substrate and electrically isolated from the first electrode; and
a third electrode disposed over the second substrate,
wherein the second electrode and the third electrode are used to detect a press-touch event.

2. The touch display device as claimed in claim 1, comprising:
a gap between the plurality of the first electrodes,
wherein the second electrode is disposed in the gap.

3. The touch display device as claimed in claim 2, wherein each of the thin film transistors is electrically connected to a data line and a scan line, wherein the data line and the scan line intersect each other, and the scan line extends in a first direction,
wherein the second electrode is disposed in the gap which is parallel to the first direction.

4. The touch display device as claimed in claim 2, wherein each of the thin film transistors is electrically connected to a data line and a scan line, wherein the data line and the scan line intersect each other, and the scan line extends in a first direction,
wherein the second electrode is disposed in the gap which is perpendicular to the first direction.

5. The touch display device as claimed in claim 2, wherein each of the thin film transistors is electrically connected to a data line and a scan line, wherein the data line and the scan line intersect each other, and the scan line extends in a first direction,
wherein the second electrode is disposed in the gap which is parallel to the first direction and is disposed in the gap which is perpendicular to the first direction.

6. The touch display device as claimed in claim 1, wherein in one control cycle, the first electrode and the second electrode selectively serve as a common electrode layer of the plurality of pixels or a touch electrode layer used to detect a touch event.

7. The touch display device as claimed in claim 1, wherein each of the thin film transistors is electrically connected to a data line and a scan line, wherein the data line and the scan line intersect each other,
wherein an electrode pattern of the third electrode overlaps with the data line or is parallel to the data line.

8. The touch display device as claimed in claim 1, wherein each of the thin film transistors is electrically connected to a data line and a scan line, wherein the data line and the scan line intersect each other,
wherein an electrode pattern of the third electrode overlaps with the scan line or is parallel to the scan line.

9. The touch display device as claimed in claim 1, wherein each of the thin film transistors is electrically connected to a data line and a scan line, wherein the data line and the scan line intersect each other,
wherein an electrode pattern of the third electrode overlaps with the data line and the scan line, or is parallel to the data line and the scan line.

10. The touch display device as claimed in claim 1, further comprising:
a connecting element disposed at a non-display region of the touch display device, wherein the connecting element electrically connects the third electrode and the first substrate.

11. The touch display device as claimed in claim 1, wherein a voltage of the third electrode is a common-electrode voltage, a ground voltage or floating.

12. The touch display device as claimed in claim 1, further comprising:
a pixel electrode electrically connected to one of the thin film transistors,
wherein the first electrode and the second electrode are disposed between the pixel electrode and the third electrode.

13. The touch display device as claimed in claim 1, further comprising:
a pixel electrode electrically connected to one of the thin film transistors,
wherein the pixel electrode is disposed between the second electrode and the third electrode.

14. The touch display device as claimed in claim 1, wherein the second substrate is a color filter substrate.

15. The touch display device as claimed in claim 1, wherein the second substrate is a backlight unit.

16. The touch display device as claimed in claim 1, further comprising:
a plurality of transmission electrodes disposed over the first substrate, wherein the plurality of transmission electrodes intersect the first electrode and the second electrode.

17. The touch display device as claimed in claim 16, wherein each of the transmission electrodes comprises:
a plurality of transmission electrode units disposed over the first substrate; and
a plurality of bridge structures, wherein each of the bridge structures is electrically connected to two adjacent transmission electrode units.

18. The touch display device as claimed in claim 16, wherein the first electrode and the second electrode are receiving electrodes.

19. The touch display device as claimed in claim 1, wherein the third electrode comprises:
a plurality of transmission electrodes disposed over the second substrate, wherein the plurality of transmission electrodes intersect the first electrode and the second electrode.

20. The touch display device as claimed in claim 19, wherein the first electrode and the second electrode are receiving electrodes.
